(19) United States
(12) Patent Application Publication
(10) Pub. No.: US 2025/0298635 A1
(43) Pub. Date: Sep. 25, 2025

(54) High Utilization Reconfigurable Asset Swapping Logistics System

(71) Applicant: Michael Gurin, Glenview, IL (US)

(72) Inventor: Michael Gurin, Glenview, IL (US)

(21) Appl. No.: 19/231,523

(22) Filed: Jun. 8, 2025

Related U.S. Application Data
(63) Continuation-in-part of application No. 18/534,402, filed on Dec. 8, 2023.

(51) Int. Cl. G06F 9/445

(52) U.S. Cl. CPC G06F 9/44505

(57) ABSTRACT

A reconfigurable asset system is provided for transporting and reconfiguring deployable devices ranging from deployable motors, deployable cargos, or other deployable assets between at least two locations. The system includes a deployable asset, a swapping with reconfiguration station, and a dynamic routing system. The swapping with reconfiguration station can change the configuration of any deployable device from a first deployable cargo physical parameter set to a second deployable cargo physical parameter set. The system uses a dynamic routing system to choose the deployable cargo, the second location, and the swapping with reconfiguration station for reconfiguring the deployable cargo. The system also includes a feedforward control system to establish a feedforward schedule database of the deployable cargo from the first location to the swapping with reconfiguration station and then from the swapping with reconfiguration station to any of the at least two locations.

### CROSS-REFERENCE TO RELATED APPLICATIONS

This application claims the benefit of U.S. Ser. No. 18/534,402 filed on Dec. 8, 2023, titled “Dynamic Multi-Queue Logistics System”, and hereby incorporated by reference in its entirety.

### BACKGROUND

Prior art includes virtually the entire field of delivery, whether it be automated or manual delivery systems, designed in most cases to meet one-way logistics delivery with the majority of the time being forward logistics tasks. Additional prior art includes standard non-autonomous vehicle delivery systems where logistics dominates with organized forward logistics tasks and relatively unorganized reverse logistics tasks. The approximate delivery cost is represented by ˜50% being labor costs, ˜10% being energy costs, and delivery equipment costs also being ˜10%.

The global drive to decarbonization and electrification of everything places substantial demand on asset utilization, energy efficiency, and reduced embodied carbon dioxide. The latter in particular demands maximum utilization of deployable assets and stationary structures utilized to support all forward logistics tasks and reverse logistics tasks as well as deployable cargo. At the same time there is substantial demand on logistics speed and automation to support logistics by autonomous vehicles (i.e., driverless thus inability to easily achieve both forward logistics tasks and reverse logistics tasks). The inability of logistics' autonomous vehicle to dock once at each destination while performing both forward logistics tasks and reverse logistics tasks from the same docking position leads to substantially higher operating and capital expenses therefore limiting the return of investment and the lifetime embodied CO2 footprint.

The further challenges of precision docking between the logistics vehicle, especially when the logistics vehicle (a.k.a. deployable asset) is transporting a secondary vehicle (e.g., a trailer) having at least loose positional and/or directional coupling with the logistics vehicle, demands a precision docking system to make up for a vehicle's docking deficiencies. It is understood that a first deployable asset (i.e., autonomous vehicle) can transport a second deployable asset (i.e., trailer), or even the second deployable asset further transporting deployable cargos, in addition to the more typical of a first deployable asset transporting deployable cargos.

The shift of delivery vehicles to ultra-high energy efficiency autonomous vehicles substantially reduces the labor costs to practically zero, the energy costs to less than 30% of the previous non-high energy efficiency vehicles (i.e., fossil fuel internal combustion engine powered vehicles) and therefore most of the logistics costs become capital equipment costs of which levelized cost of delivery becomes dominated by utilization factor (i.e., delivery cost is dominated by amortization of Capex as known in the art, as compared to variable Opex as known in the art). The least expensive logistics delivery vehicle is a vehicle that maximizes the hours per annum of active operation (i.e., faster amortization rate). And therefore, a vehicle that maximizes the hours of operation must interface with docking infrastructure at all hours of day and night, meaning automation of loading and unloading must be integral to both the autonomous vehicle and docking ports. The lack of vehicle driver and docking worker demands new logistics infrastructure capabilities and autonomous vehicle needs to minimize logistics costs. This logic remains identical for all deployable assets and deployable cargos, that being the levelized cost of the function being served by the deployable cargo is overweighted by the Capex as compared to the Opex when levelized cost of energy is greatly reduced.

The further challenge of dynamic deployable cargo between a mobile vehicle (a.k.a. mobility user) and multiple stationary locations (a.k.a. stationary user) is due to hourly, daily, monthly, and/or seasonal variations (a.k.a. variation of time of day or seasonal) to achieve high asset utilization of deployable cargo benefits from the automated reconfigurable asset system.

And the further challenge of dynamic deployable cargo between multiple stationary locations is also due to variation of time of day or seasonal to achieve high asset utilization of deployable cargo that also benefit from reconfigurable asset system.

A need exists, therefore, for a dynamic reconfigurable autonomous vehicle, trailer, and docking mechanism that enables dynamic redeployment of deployable cargo maximizing reconfiguration of deployable assets by reconfigurable asset system and pre-positioning system of docking mechanism to realize high-utilization of deployable assets and deployable cargos by frequent reconfiguring of either or both of deployable asset and deployable cargo, and to minimize the cost of achieving high-precision docking of the deployable assets.

A further need exists for re-queueing assets to minimize travel distance and time once logistics delivery tasks become particularly time sensitive.

A need also exists to utilize a two-staged docking system for proper alignment of deployable cargo in order to be precisely aligned for physical connection of the docking connector at the docking port positioned at the docking position either between multiple deployable cargos or between deployable cargo and stationary docking port. It is understood that the docking position can be any position as established by the docking mechanism in which the process of loading, unloading, or simply connecting deployable cargo takes place without the autonomous vehicle (also understanding that it can be a manual vehicle) moving again from the vehicle (or trailer) docking position to a second precision docking position enabling physical connections to take place. One exemplary instance is the need to deliver an energy storage device as deployable cargo to a stationary docking port in which the stored energy (i.e., percentage of energy available of the energy storage capacity) will be consumed, such that the transfer of energy takes place between a docking connector whether it be thermal or electrical respectively via a physical fluid or conductive wire from the energy storage device to the stationary docking port via the docking connector.

### BRIEF SUMMARY

The present invention generally relates especially to the field of autonomous vehicle transport predominantly for the movement of physical devices (e.g., deployable cargo as compared to people). More particularly, the present invention includes a reconfigurable asset swapping system that automatically via docking mechanism enables precision transfer between deployable cargo(s) and stationary docking port(s). The further inclusion of a feedforward control system, including and specifically with dynamic routing system of the autonomous vehicle or deployable asset, and vehicle loading or unloading of physical devices, pre-positioning system of docking port(s) on the deployable cargo, maximizes the value creation of the deployable cargos and deployable assets, minimizes the embodied carbon dioxide footprint, maximizes delivery efficiency, and minimizes travel time and distance (therefore transporting price as well as aggregate estimated price including amortization of Capex and variable Opex).

The present invention relates to the integration of reconfigurable asset capabilities for a high utilization reconfigurable asset swapping system, particularly for deployable assets that vary functionality, and especially for functionality that varies from a mobility user to a stationary user.

Another embodiment of the system is the vehicle leveraging a highly automated reconfigurable asset system between receiving of a deployable asset from a first location and deploying the deployable asset at a second location.

Yet another embodiment of the system is the vehicle leveraging a highly automated reconfigurable asset system between receiving of a deployable cargo from a first location and deploying the deployable cargo to a second location.

Yet another embodiment of the system is the highly automated reconfigurable asset system performs a pre-positioning within a pre-position docking envelope by a pre-positioning system of docking connectors for the docking port(s) at which the deployable asset docks at a first docking position such that subsequent precise alignment from the first docking position to a second more precise docking position reduces the precision docking time and equipment cost to achieve the precision docking, especially when the precision docking function is utilized infrequently as compared to utilization of the pre-positioning system equipment within the highly automated reconfigurable asset system at the swapping with reconfiguration station.

Another embodiment of the system is a dynamic routing system to optimize the deployment of a re-queuing asset to change the location and/or sequencing of deployable cargo closer to a projected location in which the deployable cargo will be utilized. As such the system also features dynamic addressing to properly place within a geographic mapping system where the dynamic addressing can be (and optimally) is a function of time recognizing that a re-queueing asset geographic position is optimally positioned as a variation of time of day or seasonal, or solely the randomness of predicted, projected, or actually scheduled routing of deployable asset tasks as exemplary variables that drive the optimal geographic position of the reconfigurable deployable asset where the prediction is a further function of point parameter set within the statistical probability projected database.

Another embodiment of the system is a docking port in which the docking port services the autonomous vehicle and/or trailer from a single docking position with general alignment taking place by the autonomous vehicle and/or deployable asset position and precision alignment taking place by precision docking mechanism onboard of the deployable asset.

Another embodiment of the system is the precision docking system onboard of the deployable asset leverages a compliant mechanism that enables precision alignment of docking connector at the docking port with at least one axis degree of freedom motion actuator less than an otherwise at least three degree of freedom motion actuator due to utilization of the compliant mechanism.

This summary is provided merely to introduce certain concepts and not to limit and identification of any or all key or essential features of the claimed subject matter.

### Terms and Definitions

“Actuator” refers to a device or system that varies/controls a parameter including a docking position, a physical parameter set, and a compliant mechanism to physically move any component of the system, notably a critical component within the docking port, docking connector, docking position or required to perform an orientation change, energy density change, energy storage capacity, etc. of the deployable cargo.

“Asset cargo capacity” refers to physical storage capacity of deployable cargos within the deployable asset. It is understood that asset cargo capacity can be for any deployable asset, trailer, module capable of transporting or containing deployable cargos, and/or vehicle whether it be a non-autonomous vehicle or autonomous vehicle.

“Autonomous” refers to operating independently without external control or human intervention. In the context of the reconfigurable asset system, “autonomous” refers to the system's ability to function and operate on its own.

“Autonomous vehicle”, hereinafter also referred to as “AV”, is any movable device capable of operating without any onboard driver. The preferred embodiment of a vehicle is autonomous, but it is understood that the functionality of this invention is not dependent on the vehicle being autonomous (and therefore simply referred to as vehicle). The term portable host, vehicle and autonomous vehicle are used interchangeably for the implementation of this invention.

“Axis degree of freedom motion” refers to ability of a deployable device to move or rotate around one or more axes (e.g., x, y, z, roll, pitch, yaw), particularly in the context of enabling the mating of docking connector at a docking port.

“Backup energy capacity shortfall” refers to insufficient energy capacity for any system or device that provides electricity to essential loads when the primary power source fails or is unavailable. Backup energy systems are designed to maintain the operation of critical equipment and infrastructure particularly during energy (a.k.a. power) outages, whether the disruption is brief or extended.

“Chain of custody control” refers to a process of tracking and documenting the ownership throughout any movements of record, ensuring that each device and its deployable cargo is properly accounted for and its history of movement is recorded.

“Charging price” refers to a client price established for the loading of energy onto an energy storage device.

“Compliant mechanism” refers to a flexible mechanical system that transmits force and motion through elastic deformation of its components, rather than relying solely on traditional rigid joints or moving parts. These mechanisms gain mobility from the controlled bending or flexing of their structural elements, often designed as monolithic (single piece) structures.

“Control system” refers to a set of mechanisms and algorithms that monitor and adjust the external combustion system operating parameters in real-time to optimize the external combustor reaction, including the flow rates and temperatures of the fuel and air flows. The control system is understood to be capable of monitoring and/or adjusting processes upstream and/or downstream of the external combustor.

“Deployable asset” refers to any device, whether it be an autonomous vehicle or trailer that transports deployable cargo from a first location to a second location. The deployable asset is reconfigurable via the reconfigurable asset system such that loading and unloading of deployable cargo can be autonomous via the docking connector for the docking port (collectively the docking mechanism) when the deployable asset is at a proper docking position. It is understood that the vehicle, preferably an autonomous vehicle, has at least two wheels such that any wheel active suspension system is actively controlled by the vehicle control system inconjunction with the dynamic height adjustment system to establish a docking port profile height for future docking at a docking port of the stationary user.

“Deployable cargo” includes a non-functional asset (at least during the movement from a first location to a second location in the context of the system or parked vehicle e.g., package or container) or a functional asset notably an energy storage device charger that is in physical communications with at least another deployable cargo or a docking port at a physical stationary location. Deployable cargo is also referred and interchangeable with “dischargeable cargo” or abbreviated as “DC”).

“Deployable motor” refers to a motor (e.g., pump, fan, lift, etc.) in a non-functional state during the movement from an exemplary first location to an exemplary second location that is utilized and transitions to a functional state while at the second location.

“Deployable seating” refers to a seat that transitions between a functional and a non-functional state (during the movement from an exemplary first location to an exemplary second location) such that the seat in its non-functional state increases the capacity for deployable cargo on the deployable asset.

“Deployable system” refers to a system (e.g., thermally activated system including an air conditioning or heat pump, power generation system, etc.) in a non-functional state during the movement from an exemplary first location to an exemplary second location that is utilized and transitions to a functional state while at the second location.

“Docking connector” refers to a physical interface that connects and reconfigures a deployable asset, such as a motor or cargo, with an optional though typical swapping of connector at a swapping with reconfiguration station, allowing for changes in the deployable assets' or deployable cargos' configuration enabling successful docking, as coordinated by the docking mechanism, and functional operation of the deployable asset or deployable cargo at the future location's docking port through a docking connector of the now reconfigured docking port and/or docking connector.

“Docking mechanism” refers to a mechanism or system that enables the secure and efficient transfer or exchange between a deployable asset and/or deployable cargo at the locations of a future stationary user or mobility user. This occurs by a control system having at least one actuator or regulator altering the docking position for at least one axis of the axis degree of freedom motion preferably engaging with at least one compliant mechanism, preferably onboard of the deployable asset (optionally with the aid of a pre-positioning system to reduce from the full range docking envelope to pre-position docking envelope between different locations or stations, typically involving physical or automated connections and disconnections.

“Docking port” refers to a connection point or interface on a deployable asset that allows for secure attachment and detachment to enable physical connection via docking connector within the docking port such that deployable assets and/or deployable cargos can transition between a functional state for utilization typically by a stationary user (though also optionally for a mobility user) and a non-functional state. A functional state exists for a stationary user. Or a non-functional state exists for a mobility user. The docking port is specifically preferred to be on the same side of a vehicle travel direction side for the autonomous vehicle (i.e., in other words the active steering mechanism for the autonomous vehicle enables alignment of the deployable asset's docking port to the docking port of the stationary user).

“Docking position” refers to the specific location including alignment within adequate number of axis degree of freedom motion for successful physical communication in which deployable assets and/or deployable cargos can transition between a functional state for utilization typically by a stationary user (though also optionally for a mobility user).

“Docking receiving capacity” refers to a physical space capacity preferably as a function of time, as well as unloading capability, at the docking port to receive a deployable cargo from a deployable asset arriving at an estimated arrival time to the docking port.

“Dynamic addressing” refers to a physical address, whether it be defined in a traditional street method (e.g., 123 Street A, City, State, Country) or a precise GPS coordinate system that changes notably for a swapping with reconfiguration station. The utilization of dynamic addressing specifically recognizes and optimizes the position of the swapping with reconfiguration station to minimize the aggregate logistics cost for deployable assets serving a series of next locations amongst assigned or likely (as determined by the statistical probability projected database) location candidate sets. The dynamic addressing for a swapping with reconfiguration station, a deployable asset, and a second location for reconfiguring a deployable device, based on real-time information and dynamic routing algorithms, optimizes the delivery schedule and minimizes the delays and cost for the aggregate of deployable assets, deployable cargos, etc.

“Dynamic height adjustment system” refers to a system that adjusts the deployment height of a deployable asset to accommodate changes in the environment (e.g., accumulated snow) or road variations between a first location and a second location. The dynamic height adjustment system can include suspension variations on a deployable asset transporting a deployable cargo when such capability is built into the deployable asset (e.g., active suspension system) or stationary methods (e.g., “road speed bump like) to reduce the operating envelope required by the docking mechanism for successful alignment of docking port and docking connector.

“Dynamic pricing system” refers to pricing variations at the least as a function of time and typically further as a function of at least one of: a) variation of time of day or seasonal, b) prioritization response system, c) backup energy capacity shortfall, d) utilization factors for deployable assets, e) utilization factors for deployable cargos, etc. Further pricing variations include a function of service task, forward logistics task vs. reverse logistics task, etc.

“Dynamic routing system” refers to a software component that optimizes the route for transporting and reconfiguring deployable devices, selecting the optimal swapping with reconfiguration station, second location, and deployable device configuration to minimize travel time, distance, and resource usage. The dynamic routing system includes the point parameter set for each location, including optionally for each combination of deployable asset and location, having an estimated arrival time, estimated departure time, and estimated earliest departure time (though the latter are not depicted in any figures).

“Emissions profile” refers to a graphical representation of the concentrations of various species, such as gases or particles, emitted by the combustor as a function of multiple parameters impacting combustion including any active catalyst on-stream time, real-time flow rate or real-time temperature etc., particularly downstream of the combustor.

“Enclosure” refers to a containment system that surrounds and protects the critical components from environmental exposure.

“Energy demand profile” refers to a function of time representation of the amount of energy required by a system or device over a specific period of time (e.g., typically 30 minutes during peak demand periods as determined by the energy provider). In the context of the reconfigurable asset system, it refers to a predicted or actual energy demand graph that shows the energy consumption of the deployable devices or systems at different locations and under various configurations.

“Energy density change” refers to a change in the amount of energy stored per unit weight or volume of a deployable cargo notably an energy storage device, in the context of this invention due to changes in configuration at swapping with reconfiguration station, which can be calculated and used by the dynamic routing system, dynamic addressing, and prioritization response system to optimize utilization factor of the deployable cargo.

“Energy production capacity” refers to the available or rapidly dispatch-able within statistical probability projected database capacity to supply power to typically a stationary user (though can also be mobility user) for a specified duration or amount of time.

“Energy production device” refers to a component that generates energy, whether it be electricity (a.k.a. power) or thermal energy to enable the operation of a function of a deployable cargo or deployable asset.

“Energy production failure” refers to a failure or a predicted failure as f(t) based on real-time sensors, meta sensors or statistical probability projected database of any energy production device, whether it be power generation system or other thermally activated system to generate thermal energy (whether it be hot or cold) including failure of access to stored energy from energy storage devices.

“Energy storage capacity” refers to the available or rapidly dispatch-able within statistical probability projected database capacity to supply energy to typically a stationary user (though can also be mobility user) for a specified duration or amount of time.

“Energy storage device” refers to any device that is charged with energy for subsequent discharge of energy at a later time. The energy storage device can store either electricity (a.k.a. battery) or thermal energy (of which can be hot or cold).

“Environmental system” refers to the air flow within the portable host to regulate at least the temperature of the vehicle interior of the portable host. The environmental system is typically referred to as air conditioning or fresh air intake via the incoming air vent for the portable host.

“Estimated arrival time” refers to the predicted time of arrival for a deployable asset or a deployable cargo at a specific location, taking into account the dynamic routing system's selection of the swapping with reconfiguration station and the feedforward control system's delivery schedule.

“Estimated price” refers to the predicted cost or financial value, based on deterministic rate structures or predictive rate structures based on statistical probability projected database. Preferably the estimated price is a function of time including the accounting for variations of time of day or seasonal.

“Feedback command” refers to an instruction that controls via any regulator based on real-time data, such as temperature or air flow rate, to maintain optimal operating conditions though prior to any adjustment by the feedforward command.

“Feedback comparator” refers to a control component that compares the current state of a controlled parameter from the point parameter set with a predetermined setpoint, and adjusts a regulator in accordance to the feedback command adjusted by the feedforward command.

“Feedback error” refers to a control action taken by the system to correct the difference between the desired and actual process conditions.

“Feedback loop” refers to a control mechanism that uses the output of the process or system to provide input to the same system, in order to regulate, stabilize, or correct its behavior, in this case, based on the feedback error.

“Feedback module” refers to a standard feedback loop that monitors and adjusts the process variables in real-time to optimize the performance and efficiency of the system.

“Feedback schedule database” refers to a plan or schedule for delivering a deployable asset and/or deployable cargo from one location to another, taking into account the current location, configuration, and routing of the asset, as well as any potential delays or disruptions. The feedback schedule database is based solely on current real-time known parameters selected from the group of point parameter sets and/or physical parameter sets.

“Feedforward and feedback loop control system” refers to the combination of controlling components first using a feedforward control system immediately followed by a feedback control system such that control parameters of the feedback control system are a function of the feedforward control system. For clarity, it is understood that the term control system is at least a feedback loop control system and preferably a feedforward and feedback loop control system.

“Feedforward command” refers to an instruction that controls at least one of any regulated parameters based on real-time data, such as temperature or flow rate, to maintain optimal operating conditions modifying the adjustment beyond by the feedback command.

“Feedforward comparator” refers to a control component that compares the current state of a controlled parameter from the point parameter set with a predetermined setpoint and feedforward inputs.

“Feedforward control system” refers to a control system that uses real-time measurements of the process variables to adjust the inputs to the process in order to maintain desired output, without relying on feedback from the process itself. Furthermore, it is a type of control system that takes preemptive action based on known or anticipated disturbances to improve system performance. It operates by directly manipulating the system's input using a model or prediction of how disturbances will impact the output, rather than reacting to the system's output after it has been affected.

“Feedforward inputs” refers to parameters or settings that directly influence the operational conditions of a system, such as the real-time actuator, which are used to control systems' operation in real-time yet looking proactively and not simply based on inputs of a typical feedback module.

“Feedforward modified command” refers to a control signal that is sent directly to the process or system being controlled, without going through a feedback loop, to modify the command or action being taken. In the context of the system, it would refer to a control signal that could directly modify any active parameter from the point parameter set.

“Feedforward module” refers to the feedforward and feedback loop control system that specifically addresses proactive modifications beyond a traditional feedback loop.

“Feedforward outputs” refers to any parameter of the point parameter set that regulates any regulator within the system to maintain a desired operating condition based on the combination of feedback command and adjustments made by executing the feedforward command.

“Feedforward schedule database” refers to a plan or schedule for delivering a deployable asset and/or deployable cargo from one location to another, taking into account the current location, configuration, and routing of the asset, as well as any potential delays or disruptions. The feedforward schedule database is based on current real-time known parameters and predictive models including parameters as a function of time and statistical probability projected database selected from the group of point parameter sets and/or physical parameter sets.

“Fixed schedule database” refers to known and deterministic (as opposed to predictive or non-deterministic parameters) pre-defined schedules for deployable cargo and/or deployable assets, which are used to plan and organize the reconfiguration of deployable cargos and transportation by deployable assets between locations, in advance of the actual delivery and without taking into account real-time perturbations or parameter variations predicted by statistical probability projected databases.

“Forward logistics task” refers to the delivery of a DC at a discharge location in which the DC will be utilized at that discharge location. An exemplary Forward Logistics Task is a delivery of clean dishes and/or clean clothing, fully (or at least fuller than previously) charged energy storage device, delivery of food, delivery of on-line ordered product, etc.

“Full range docking envelope” refers to the complete area or volume within which a deployable device can be fully accommodated and properly aligned without leveraging a pre-positioning system in which a deployable asset or deployable cargo has physical connection of docking connector and docking port at a next location or set of next locations.

“Geofence” refers to a virtual perimeter or boundary defined around a real-world geographic area using technologies such as GPS, RFID, Wi-Fi, or cellular data. Geofences can be any size or shape, from a simple circle around a point (defined by latitude, longitude, and radius) to more complex polygons that match the contours of buildings, neighborhoods, or other designated zones. In summary, a geofence is a software-defined, invisible boundary that enables automated responses based on the real-time location of devices relative to a specific geographic area.

“Guide rail” refers to a predefined physical object that aid the docking connector to establish alignment and physical connection by the docking connector of the deployable cargo or deployable asset at a next location's docking port. The guide rails enable the docking mechanism to have lower precision of alignment as compared to a docking mechanism not able to leverage guide rails.

“Hollow beam interior” refers to a structural component, specifically the internal space or cavity within a hollow structural element, such as an I-beam or a channel, that serves as a passage or conduit in this context for fluids, or gases.

“Horizontally oriented module” refers to a deployable cargo, including and notably energy storage devices, that are mounted in a predominantly horizontal orientation relative to the deployable asset and/or docking port. The inventive swapping with reconfiguration station has the preferred capability to perform orientation changes from a predominantly horizontal to a predominantly vertical orientation and vice versa.

“Intermediate staging station” refers to a node or location inclusive of swapping with reconfiguration stations or simply physical locations in which a reconfigurable asset system is not utilized yet at least one queueing lanes is utilized. In this context a first deployable asset with either an on-board physically coupled deployable cargo or non-coupled deployable cargo arrives at the intermediate staging station such that at a minimum the queueing order of deployable cargos changes prior to departing for the next locations or the deployable cargo leaves the intermediate staging station on a different deployable asset than the deployable cargo arrives to the intermediate staging station.

“Inventory control database” refers to a database that stores and manages data related to the deployment, configuration, and location of deployable assets, including their status and historical deployment information. Notably the inventory control database reflects in real-time and/or predicted availability of deployable assets and deployable cargos as a function of time.

“Location” refers to a physical position of any component within the system is located at a specific point in time. An instance of the system including decoupled components of the system, given its modularity and ability to be appropriately sized for portability and/or on-vehicle mobility, such that a portable host is transported from a first location to a second location. Another instance is a logistics vehicle moving the portable host from a first location to a second location.

“Location candidate set” refers to a set of potential locations or nodes in a network that are considered suitable for routing the deployable device, where suitable is for both deployable assets and deployable cargos where the deployable cargo executes its intended functionality. In other words, suitable means that the deployable cargo successfully docks via the docking mechanism and therefore must have compatibility of docking port, docking connector, and pre-position docking envelope. It is anticipated that a high-level of interchangeability is inherent in the deployable cargos and deployable assets especially after undergoing reconfigurations by the reconfigurable asset system at the swapping with reconfiguration station. In this manner the dynamic routing system handles the complexity of establishing a preferred feedforward schedule database or at least a scheduled based on the fixed schedule database or feedback schedule database.

“Meta sensor” refers to a calculated function that is typically calibrated or measured on a previous set of data preferably utilizing machine learning to prevent the necessity for expensive or impossible to determine from direct measurement of based on point parameter set and/or physical parameter set. It is understood that a meta sensor can be used to replace any physically measured amount of from the point parameter set. In fact, the actual term of a real-time parametric value can interchangeably be a calculated and projected value as determined by a minimum viable set of operating conditions in which prior training has taken place.

“Mobility user” refers to any deployable asset capable of transporting energy storage devices or energy production devices, whether energy storage devices or energy production devices are detachable from the deployable asset (i.e., a deployable cargo) or permanently coupled (i.e., non-decoupled deployable asset with deployable cargo).

“Multifunctional structural beam” refers to a structural component having a hollow beam interior within the portable host such that the structural component serves as a structural element for the portable host when in transportation mode and as a fluid or gaseous carrier to and from the external combustor when in stationary mode.

“Orientation change” refers to a change in the physical configuration or layout of a deployable asset at the swapping with reconfiguration station by the reconfigurable asset system, such as a deployable motor or deployable cargo, to a new position or mode of operation from a predominantly horizontally oriented module to a predominantly vertically oriented module.

“Physical parameter set” refers to a minimum set of individual parameters characterizing physical metrics, particularly physical metrics that are a function within the control system having a point parameter set.

“Point parameter set” refers to a minimum set of individual parameters for regulating control of any variable condition included by the control system as a function of real-time operating conditions consisting of at least two of meta sensor or actual sensor measuring a physical data point specific to the physical point in which the actual sensor is placed. The set of individual parameters can include a minimum and maximum real-time air flow rate, and a minimum and maximum real-time temperature.

“Power generation system” refers to the aggregate of a compression stage, a combustion stage (or thermal input), and expansion stage to create mechanical and/or electrical energy. It is a fundamental goal of a power generation system that integrates the external combustor with all of the external combustion system components including combustor component set and non-combustor component set.

“Pre-position docking envelope” refers to new and smaller envelope compared to the full range docking envelope as established by a docking mechanism at the inventive swapping with reconfiguration station having a reconfigurable asset system.

“Pre-positioning system” refers to a component or module within the reconfigurable asset system that pre-positions or stores the deployable devices' docking port and/or docking connector within pre-position docking envelope by the docking mechanism in a state of being ready for more rapid deployment and/or more rapid alignment at the next location. An additional fundamental benefit realized by utilizing the pre-positioning system is to reduce the capital cost of lower utilization docking mechanisms. The capital cost of a docking mechanism is lower for a reduced physical distance needing to be covered as well as a reduced number of axis degrees of freedom motion for docking at a docking port at the next locations. In this manner the swapping with reconfiguration station increases the effective number of compatible locations within an expanded location candidate set.

“Prioritization response system” refers to a deterministic or non-deterministic (e.g., heuristic or machine learning) system establishing rules and algorithms to vary dynamic routing system at a minimum, and preferably also dynamic addressing, dynamic pricing system, and dynamic height adjustment system realizing a numerical prioritization amongst locations within at least one location candidate set. A resulting routing schedule is established by the dynamic routing system for each deployable asset and deployable cargo.

“Profile height” refers to the distance from the bottom to the top of the non-combustor component set, typically measured in a vertical or height direction.

“Queueing lane” refers to the movement of dischargeable cargo within a controlled area that is physically or virtually constrained. It is understood that the spelling of queueing and queueing are used interchangeably.

“Re-queueing asset”, also referred to as a resequencing asset, is a physical device capable of receiving at least two DCs from the queueing lane such that the order of discharges of each DC is subsequently changed, loaded back into a queueing lane (though understood that queueing lane is not necessarily on-board of the same vehicle) for the specific purpose of yet subsequent discharge order from that queueing lane that is different than the initial discharge order.

“Reconfigurable asset swapping system” refers to a mechanism that enables the dynamic reconfiguration of deployable assets, such as deployable motors or deployable cargos, at designated swapping with reconfiguration stations, by rapidly changing their physical parameters, in order to optimize their deployment, functionality, or transportation between multiple locations.

“Reconfigurable asset system” refers to the physical method, as well as software methods, of reconfiguring a deployable asset or deployable cargo which takes place within the swapping with reconfiguration stations.

“Reconfiguring”, also referred and interchangeable with “reconfigurable” or “repositionable”, changes the placement of individual DCs, relative to each other, within the vehicle transporting the DC, within the trailer connected to a vehicle transporting the DC, and/or the movement of a docking port on the individual DC to enable subsequent precision alignment of the onboard docking port to an off-board docking port (relative to the individual DC) such that the order of individual DCs is altered for subsequent use off-board the DC at a next location or the combination of a next first location and at least one next subsequent location post the next first location.

“Resequencing”, also referred and interchangeable with “re-queueing”, changes the order of individual DCs, relative to each other, within the queueing lane(s) such that the order of individual DCs is altered for subsequent discharges from the queueing lane(s).

“Reverse logistics task” refers to the retrieval of a DC from a user location (in most instances a previous discharge location) in which that DC will be utilized again at a next discharge location, in many cases the DC will have a service task performed at a service asset prior to that next delivery. An exemplary Reverse Logistics Task is the retrieval of dirty dishes, dirty clothing, at least partially consumed energy from an energy storage device, post-service usage of a shared resource (e.g., tools, appliances), waste disposal recovery, dirty water, etc.

“Service asset” refers to a physical device capable of performing an operational task on a DC. Exemplary operational tasks include washing dishes, cleaning clothing, charging energy storage devices, quality control checks such as confirming a lack of damage due to use of a shared resource prior to a next subsequent use of that share resource by a next user. It is understood that a service asset can have integral re-queueing capabilities in which case the service asset is also a re-queueing asset.

“Service task” refers to an operational task including washing dishes, cleaning clothing, charging energy storage devices, quality control checks such as confirming a lack of damage due to use of a shared resource prior to a next subsequent use of that share resource by a next user.

“Setpoint” refers to a predetermined parametric value that serves as a target or reference point for controlling the active parameter.

“Shared resource” refers to a physical asset or system that can be accessed and used by multiple deployable devices or units simultaneously and can be dynamically reconfigured to support different deployable assets and/or deployable cargos or missions. In particular shared resources are utilized by multiple mobility users and/or stationary users (i.e., not just the owner of the actual deployable asset or deployable cargo).

“Stationary mode” refers to a mode of operation in which the external combustion system is installed and integrated with a fixed infrastructure, such as a building or a ground-based platform, and is designed to operate continuously and efficiently under normal environmental conditions. The stationary mode occurs only upon secure connection between the non-combustor docking mechanism and combustor docking mechanism, and authenticated connectivity and communications between the non-combustor component set and combustor component set.

“Stationary user” refers to a user who remains at a fixed location, as opposed to a “mobile user” that utilizes the deployable cargo during movement between locations.

“Statistical probability projected database” refers to a database of parameters, preferably as a function of time, in which the predicted values account for statistical probabilities of at least one parameter (and preferably all parameters that are not fixed in time). Within the context of this system, the statistical probability projected database includes predicted inventory control database based on actual operating hours of a deployable asset and its deployable cargos relative to its anticipated lifetime hours (or maintenance interval), based on predictive weather that can impact parameters including feedforward schedule databases, energy demand profile, energy storage capacity, forward logistics tasks, and reverse logistics tasks.

“Swapping with reconfiguration station” refers to a station or device that can reconfigure the physical parameters of a deployable asset and/or deployable cargo by changing its configuration, allowing it to be redeployed or repurposed for different tasks or locations by the on-site reconfigurable asset system. The swapping with reconfiguration station can also hereinafter be referred to as “SR Station”.

“Thermally activated system” refers to a system that utilizes resulting heat by combustion of fuel within a combustor, in the context of this invention within the external combustor and the broader range of interconnected devices within the combustor component set. It is recognized in the art that this includes power generation system, environmental system (e.g., air conditioning, heat pumps, boilers, etc.), and processes (e.g., drying, washing, cooking, etc.).

“Time” refers to In the context of reconfigurable asset systems, “time” refers to a scheduling parameter used to establish a delivery schedule of deployable assets, specifically a time window or interval during which a deployable asset and/or deployable cargo is expected to be transported from one location to another in addition to a time window or interval during which the deployable cargo will be utilized at a location, and in addition to a time window or interval during which the deployable asset will be docking at a location's docking port (i.e., the deployable cargo is not yet available to perform its function for a stationary user) or a time window or interval during which the deployable cargo is at the swapping with reconfiguration station (i.e., the deployable cargo is not yet available to perform its function for a mobility user).

“Trailer” refers to a non-motorized vehicle designed to be pulled behind a motor vehicle, such as a car, truck, or tractor. The trailer is used for transporting deployable cargo, whether the trailer encloses the deployable cargo or is an open (i.e., non-constrained at least in terms of covering the deployable cargo. In the context of this invention a trailer further includes a device that becomes temporarily directly and physically coupled to a host vehicle such that either the trailer wheels are raised, not utilized, or removed while directly coupled to the host vehicle. Further the reference to trailer is understood to further include the vehicle industry term of “top hat” though in the inventive instance it is the functional-driven portion, hereinafter called “functional top hat”, of the vehicle rather than the traditional reference to being the styling-driven portion of a vehicle. A top hat generally includes the upper bodywork, interior, and exterior of a vehicle—in a nutshell, everything “on top” of a vehicle platform, with the platform being all aspects associated with the movement of the vehicle from a first location to a second location (or the context of this invention from a current location to a next location or next SR Station).

“Transportation mode” refers to a state in which the system is not connected or coupled to a stationary host, and the non-combustor component set is in a portable configuration, ready for transport or deployment.

“Transporting price” refers to an aggregate price specific to the logistics particularly for redeployment of a deployable cargo, which preferably accounts for the deployable asset utilized for the movement of the deployable cargo from a first location to a next location. The particularly preferred aggregate price disregards the additional cost associated with the distance segment increase associated with including intermediate staging station or swapping with reconfiguration station. The latter being analogous to airline mileage award points that disregard the additional travel distance due to stops or plane changes between the originating location and final destination location.

“Variation of time of day or seasonal” refers to changes in at least one parameter of physical parameter set or point parameter set that varies as a function of time, whether that time is based on a time of day, a day of the year, or otherwise seasonal changes as known in the art. The anticipated variations include inventory control database, statistical probability projected database, fixed schedule database.

“Vehicle interior” refers to a physical space within the portable host, typically where passengers, and/or driver can also be transported from a first location to a second location concurrent with deployable cargos. It is understood that deployable seating is within the autonomous vehicle's vehicle interior, and that deployable seating can in fact be removed from a deployable asset or that the deployable seating can be reconfigured (both by the reconfigurable asset system) into a stowed position such that additional deployable cargo can be transported unencumbered by non-used seating due to absence of passengers or drivers for at least a segment of travel between a first location to a second location (including any additional stops to intermediate staging stations or swapping with reconfiguration stations). As known in the art, the preferred seat stowed away position is upward such that the deployable cargo has uninterrupted flow on the vehicle interior's floor.

“Vehicle movement control system” refers to on-board control systems including all actuators, regulators, motors, power generation system, and environmental system required as known in the art for movement of the vehicle from any first location to any second location.

“Vehicle travel direction side” refers to side of the vehicle that is directed in the vehicle's intended movement or travel direction, typically the front of the portable host.

“Verification of delivery acceptance method” refers to a process of confirming that the deployable device has been successfully reconfigured at the destination location, typically through feedback from sensors or other data sources, to ensure that the device is in the desired configuration and ready for use.

“Vertically oriented module” refers to a deployable cargo, including and notably energy storage devices, that are mounted in a predominantly vertical orientation relative to the deployable asset and/or docking port. The inventive swapping with reconfiguration station has the preferred capability to perform orientation changes from a predominantly horizontal to a predominantly vertical orientation and vice versa.

“Wheel” refers to a device as known in the art for movement of the portable host.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates the feedforward control system preferably utilized for control of the reconfigurable asset swapping system.

FIG. 2 illustrates is generally a side view of the key components of the reconfigurable asset swapping system, in addition to the inter-relationships of those key components.

FIG. 3 illustrates the key components of the reconfigurable asset system control system, in addition to the inter-relationships of those key components.

FIG. 4 illustrates is generally a side view of the key components, having more detail than FIG. 2 of a subset of the key components of the reconfigurable asset swapping system, in addition to the inter-relationships of those key components.

FIG. 5 illustrates an autonomous vehicle, also known as deployable asset, with details, including various inter-relationships with the location at which it deploys deployable cargo.

FIG. 6 illustrates the inter-relationships of swapping with reconfiguration stations, intermediate staging stations, and locations in which deployable assets deploy deployable cargos within the reconfigurable asset swapping system.

### DETAILED DESCRIPTION

Here, as well as elsewhere in the specification and claims, individual numerical values and/or individual range limits can be combined to form non-disclosed ranges. Exemplary embodiments of the present invention are provided, which reference the contained figures. Such embodiments are merely exemplary in nature. Regarding the figures, like reference numerals refer to like parts. As used herein the term “substantially” is used to indicate that exact values are not necessarily attainable especially when the point parameter set is a function of the parameters within the statistical probability projected database. In some embodiments of the present invention, the term “substantially” is defined as approaching a specific numeric value or target to within 20%, 15%, 10%, 5%, or within 1% of the value or target. In further embodiments of the present invention, the term “substantially” is defined as approaching a specific numeric value or target to within 1%, 0.9%, 0.8%, 0.7%, 0.6%, 0.5%, 0.4%, 0.3%, 0.2%, or 0.1% of the value or target. As used herein, the term “about” is used to indicate that exact values are not necessarily attainable. Therefore, the term “about” is used to indicate this uncertainty limit. In some embodiments of the present invention, the term “about” is used to indicate an uncertainty limit of less than or equal to +20%, +15%, +10%, +5%, or +1% of a specific numeric value or target. In some embodiments of the present invention, the term “about” is used to indicate an uncertainty limit of less than or equal to +1%, +0.9%, +0.8%, +0.7%, +0.6%, +0.5%, +0.4%, +0.3%, +0.2%, or +0.1% of a specific numeric value or target. {Alternatively—As used herein, the term “about” or “approximately” can mean within an acceptable error range for the particular value as determined by one of ordinary skill in the art, which can depend in part on how the value is measured or determined, e.g., the limitations of the measurement system. For example, “about” can mean within I or more than I standard deviation, per the practice in the art. “About” can mean a range of ±20%, ±10%, ±5%, or ±1% of a given value. Where particular values are described in the application and claims, unless otherwise stated, the term “about” means within an acceptable error range for the particular value. The term “about” can have the meaning as commonly understood by one of ordinary skill in the art. The term “about” can refer to ±10%. The term “about” can refer to ±5%.}

As used herein, the term “optional” or “optionally” means that the subsequently described event or circumstance can or cannot occur, and that the description includes instances where the event or circumstance occurs and instances where it does not.

It is understood that throughout this specification the identifiers “first” and “second” are used solely to aid the reader in distinguishing the various components, features, or steps of the disclosed subject matter. The identifiers “first” and “second” are not intended to imply any particular order, amount, preference, or importance to the components or steps modified by these terms. However, the identifiers “next” is intended to imply a particular order and importance to the components or steps modified by this term. To further clarify, next specifically implies when associated with a first instance is prior to the next second instance with respect to time sequence (recognizing that often a first instance can be followed not only by a second instance but also a third or even fourth instance) such that next explicitly implies that the step is realized for the first instance prior to the second instance (or third instance). The identifiers “previous” and “prior” is intended to imply a particular order and importance to the components or steps modified by this term. To further clarify, previous specifically implies when associated with a previous first instance is prior to the second instance with respect to time sequence (recognizing that often a third instance can be preceded not only by a second instance but also a first instance) such that previous (or prior) explicitly implies that the step is realized for the first instance prior to the second instance (or third instance).

The following is a general description of the inventive reconfigurable asset system and the vehicles (both autonomous vehicle and human-directed) also featuring reconfigurable deployable asset (i.e., trailers) and docking ports is particularly both novel and a necessity for autonomous vehicles. This is especially important as the autonomous vehicle not only lacks a driver for moving the vehicle from a first location to a second location, but also inherently lacks the means normally attributed to the driver of performing the accompanying task upon arrival of human loaders and unloaders of cargo (used interchangeably with deployable cargo) at least that are roaming with the vehicle) from the vehicle and/or deployable asset.

The constraint of no human (i.e., personnel) as well as reducing the great expense of an automated robot (including humanoid) cargo movers on-board the autonomous vehicle eliminates any accompanying human to also connect the deployable cargo into a useable docking position in order to perform its designated task at the unloaded location. The inventive vehicle therefore also features inventive docking mechanism to reduce the positioning precision required for the vehicle and/or trailer with respect to the docking alignment, especially when the docking alignment requires precision connections between the deployable cargo to execute its functionality. It is a feature of the inventive system to reduce or eliminate underutilized capital equipment, which would clearly be the case if an automated robot is on each deployable asset as by definition the automated robot is only necessary for the small fraction of time in which the autonomous vehicle is manipulating docking connector to a docking position for proper alignment at the docking port. The preferred docking port point parameter set includes a parameter, preferably as a f(t) accounting for the docking receiving capacity at the next locations 224.

Swapping with Reconfiguration Station “SR Station”

The inventive system features a swapping with reconfiguration station to maximize automation (and therefore minimize redeployment costs of deployable cargo) requirements for reconfiguring the deployable cargo from the physical configuration required to perform its tasks at a previous location to a new physical configuration to perform its tasks at a next location (and potentially even a next few locations having sufficiently compatible requirements amongst all of the next locations (prior to routing via dynamic routing system to either a swapping with reconfiguration station or intermediate staging station) to perform its task at both the first next location and the at least second next location.

A first embodiment of a required reconfiguration is the movement of the deployable cargo when the deployable cargo is an energy storage device (i.e., electrical or thermal battery, universally referred to as “battery” in the context of this invention and preferably gain its stored energy percentage less than energy storage capacity at a charging price by a deployable asset notably a thermally activated system including a power generation system or environmental system). The energy storage device, such as an electrical battery, will in most instances have different energy storage capacity requirements at the previous location as compared to the next location. Failing to reconfigure the energy storage device will either lead to a premature requirement for movement of the energy storage device to a next location for charging at the charging price therefore requiring a second delivery of another battery to meet the requirements at the next location by a deployable asset, or under-utilized use of energy of the total energy storage capacity at the next location. The inventive functionality of the SR Station also enables hourly, daily, monthly, quarterly, seasonal, or specific event driven changes in energy storage capacity to take place through reconfiguring at the SR Station. The preferred embodiment is such that the reconfiguration takes place during a normal delivery of a charged battery to a next location in the replacement of an otherwise discharged battery (a.k.a. deployable cargo).

The redeployment of the deployable cargo from a previous location to a next location requires vehicle and trailer alignment such that the deployable cargo is automatically and seamlessly physically connected to a docking position by a docking connector such that deployable cargo docking connectors within the docking ports are physically in communication with the next location's docking port(s). Variability associated with a vehicle's differences, trailer differences, and even next location's docking port X, Y, Z coordinates relative to the deployable cargo docking port(s) X, Y, Z coordinates are preferably adjusted for the deployable cargo while at the SR Station. Repositioning of the deployable cargo's docking ports at the SR Station reduces the automation equipment functionality (and therefore its costs) and its respective precision for each deployable cargo. It is an inventive feature of the system is to at least perform a pre-positioning system of the deployable cargo docking port(s) at the SR Station to maximize equipment utilization rates of reconfigurable asset system, which reduces the total system cost of redeploying the deployable cargo and deployable asset.

The SR Station is operational to change the orientation of individual deployable cargo, also hereinafter referred to as “DC”, particularly for DCs having individual and multiple modules within the deployable asset. One such embodiment is a DC that is an energy storage device such that utilization of the energy storage device within a first vehicle requires reconfiguring of the energy storage device with an orientation change as a horizontally oriented module and a second (i.e., next) vehicle requires reconfiguring of the energy storage device to a vertically oriented module (or vice versa). This instance can be the first vehicle having externally accessible floor mounted energy storage devices and the second vehicle having internally accessible center mounted energy storage devices.

The SR Station is also operational to change individual modules within the deployable asset such that higher energy density of energy storage devices having an energy density change replaces a relatively lower energy density energy storage devices (i.e., less expensive per energy storage capacity) when either the autonomous vehicle, deployable asset, or deployable cargo at the next location requires a higher total energy storage capacity (and yet is physically space constrained). Changing the total energy storage capacity in another embodiment is such that a trailer being moved by an autonomous vehicle from a previous location to a next location includes the utilization of both a trailer inventory control database and an energy storage device inventory control database in reconfiguring the energy storage device as selected from within an inventory of energy storage devices as depicted in an inventory control database at the SR Station into a deployable asset as selected from within an inventory of deployable assets as depicted in an inventory control database at the SR Station properly sized to meet the energy demand profile (i.e., functional task specification at the next location). The SR Station additionally is reconfiguring the type of docking connector onto the deployable asset (or trailer) to the specifications for docking at the next location. The SR Station utilizes the docking connectors compatible with the docking port as selected from an inventory of docking connectors as depicted in the inventory control database to ensure that the system can meet the requirements at the next location. Failure to meet the requirements at the next location, whether it be an inventory failure of any of the lack of energy storage devices, deployable asset, docking connector, trailer, autonomous vehicle or even docking port types leads the inventive system to utilize the feedforward control system to determine a second SR Station (preferably closest to the next location from the available other SR Stations) to fulfill the transport and fulfillment of a deployable cargo within a deployable asset utilizing an autonomous vehicle for movement of the deployable cargo to the next locations. In this manner, the inventive reconfigurable asset system utilizes both a dynamic sizing of traveling trailer, as well as dynamic sizing of receiving energy storage device size, as well as dynamic selection of docking connector types to successfully perform the deployable cargo functional tasks at the next locations. The feedforward control system also utilizes the projected scheduling (i.e., utilization rate and precise scheduling from the fixed schedule database or feedback schedule database or feedforward schedule database) of the reconfigurable asset system to perform the required deployable cargo, trailer, and/or autonomous vehicle reconfiguration required in a timely manner to meet the schedule demands for the next locations within the entire network of next locations.

The feedforward and feedback loop control system also consists of at least one of a fixed schedule database for each next location requirement as a function of time “f(t)” and fixed schedule database for each SR Station that aggregates the next locations' requirements as f(t). The schedule database can optionally and preferentially include a statistical probability projected database as f(t) for each next location as well as an aggregated of next locations' requirements as f(t) for each SR Station. The dynamic routing system, dynamic addressing, and dynamic pricing system utilizes optimization algorithms (both deterministic, heuristic, and machine learning) utilized by the feedforward and feedback loop control system fundamentally integrate forward logistics task and reverse logistics task requirements for each next location and each SR Station to determine routing for deployable cargo delivery. In this manner, the inventive system consists of a fleet of autonomous vehicles (and though not preferable also non-autonomous vehicles. Furthermore, any time sensitive deployable cargo delivery dynamically shifts from a first delivery schedule (whether it be a fixed schedule database, feedback schedule database or preferably feedforward schedule database) operating on a statistical probability projected database to a second delivery schedule operating on a (whether it be a fixed schedule database, feedback schedule database or preferably feedforward schedule database). A time sensitive deployable cargo delivery that either fails or has an increasing probability of failing to meet its absolute delivery time requirement dynamically shifts from a first feedforward schedule database to either a feedback schedule database or schedule within a fixed schedule database.

The feedforward schedule database system and the feedback schedule database utilize a further dynamic routing system combined with the next locations' requirements as f(t) database to accelerate deployable cargo delivery (or deliveries) in which a method of routing and designated deliveries are assigned to a feedforward schedule database to dynamically determine an assigned autonomous vehicle (i.e., deployable asset), an assigned deployable asset where the deployable asset is a trailer when necessary or desired to be decoupled from the autonomous vehicle upon arrival at the next location, and an assigned deployable cargo from the SR Station inventory control database (or even from subsequent SR Station inventories along the dynamic route) to deliver more than one deployable cargo to a next location or a series of next locations. The feedforward schedule database system then utilizes the previously filed invention of reconfigurable asset swapping system to establish the queueing order requirements and then utilizes this inventive reconfigurable asset swapping system to configure the assigned autonomous vehicle, the assigned trailer, and the assigned deployable cargo within the assigned trailer. The feedforward schedule database system includes additional deployable cargo deliveries based on the inventory control database of deployable cargo at their respective SR Stations along the designated dynamic routing system including scheduled stops at next swapping with reconfiguration stations. The feedforward schedule database system specifically includes deployable cargos that are projected to be required at the next locations along the designated route and/or when the trailer and autonomous vehicle have available transport capacity are assigned and then configured for proper placement and sequencing into the designated trailer, specifically for the purpose of increasing the accuracy of the statistical probability projected database as f(t) for each next location as well as an aggregated of next locations' requirements as f(t) for each SR Station by at least 5 percent (or preferably by at least 10 percent, particularly preferred by at least 20 percent) such that the DC delivery transitions from a statistical probability projected delivery to a fixed firm delivery). Notably, the ability to accelerate a DC delivery is especially suitable for DCs of the energy storage device type following the verification that the next location has first docking receiving capacity at the projected autonomous vehicle and trailer docking schedule for that specific next location, then subsequent verification that the next location has energy storage device storage capacity for the additional accelerated delivery of energy storage device, and finally subsequent verification that the next location requires the additional accelerated delivery of energy storage device prior to that energy storage device having a capacity being required at another next location candidate (collectively referred to as “Verification of Delivery Acceptance Method” or “VDA Method”.

The inventive reconfigurable asset swapping system also utilizes the feedforward schedule database control system to move DCs, especially DCs that are shared resources (i.e., a deployable asset or deployable cargo that is not owned, designated or uniquely assigned solely to a specific next location) to a next SR Station (or closer to an ultimate SR Station requiring that DC within its inventory at a future time prior to being required at a different SR Station that has an inventory deficiency as f(t)). The movement of this DC undergoes VDA Method at the next SR Station and preferably includes VDA Method for any subsequent SR Stations as f(t) required until the DC arrives at its designated SR Station for ultimate delivery of the DC at the next location in which that DC is required as f(t).

The inventive reconfigurable asset swapping system, especially when DC deliveries are accelerated for delivery to a next location, recognizes that the dynamic pricing system for services performed utilizing the delivered DC at the next location accounts for the accelerated staging of the DC prior to actual next location DC service requirements as f(t) being discounted by at least 1 percent (and preferably at least 5 percent, and particularly preferred at least 20 percent). The inventive reconfigurable asset swapping system, especially when DC deliveries are accelerated for delivery to a next location, recognizes that the dynamic pricing system for ownership of the delivered DC at the next location accounts for the accelerated staging of the DC prior to actual next location DC ownership requirements as f(t) being discounted by at least 1 percent (and preferably at least 5 percent, and particularly preferred at least 20 percent). The particularly preferred reconfigurable asset swapping system is a system that serves schedule demand for DCs and additionally a dynamic DC demand generation system (particularly preferred with dynamic pricing) to utilize available capacity within the designated autonomous vehicle having a designated trailer with already designated deployable cargos for delivery at a next location (as well as subsequent next locations along the designated routing). Notably the dynamic deployable cargo demand generation system includes at least one of ownership deployable cargos (e.g., food, coffee, flowers, produce, seedlings, or virtually any consumer product; or additionally virtually any functional device ranging from data center modules, appliances including power generation system and environmental system or even washing machines, tools, furniture, etc.), shared resource DCs (a.k.a. service DCs including energy storage devices, rental equipment as known in the art including vacuum cleaner), and reverse logistic DCs (a.k.a. eliminating personal driving to perform services e.g., depositing a check at a bank, mailing a letter at postal center, returning a purchased item to a specific retail store whether the store is virtual or physical, dry cleaning or laundry cleaning of clothing, cleaning of dishes, etc.).

The fundamental integration and combination of the reconfigurable asset swapping system with the dynamic deployable cargo demand generation system drives down the total delivered cost of virtually anything that is transported in a deployable asset. Logistics assets (e.g., autonomous vehicle, deployable asset including trailer, and even modules or containers that further aggregate DCs) with a fleet of ultra-high-efficiency multi-modal autonomous vehicles leveraging a network of reconfigurable asset swapping systems (including re-deployable SR Stations preferably using dynamic addressing whether on an hourly, daily, monthly, seasonal or even event driven basis responding to variation of time of day or seasonal) achieves the highest utilization rate across the fleet of network assets. The further ability for an SR Station to be embedded into distributed and decentralized renewable energy assets (i.e., specialized power generation systems that are typically stationary including solar, wind, nuclear, geothermal, etc.) also has the significant benefit of driving down real estate costs for the deployable assets. Yet the further electrification of the logistics assets combined with on-demand on-site hydrogen production drives down the energy and maintenance costs of operating the autonomous vehicle and the SR Station significantly. The SR Station is critical to achieving a very high utilization rate of the logistics assets (collectively the deployable assets, trailers, autonomous vehicles) such that the logistics costs become almost negligible. At that point in time the SR Station empowers true disintermediation and a next level of circular economy. As known in the art, high utilization rates achieve a high return on investment of automation equipment (e.g., robots, humanoids, automated guided vehicles, 3d printing or other additive manufacturing equipment, manufacturing equipment, or automated clothing folding equipment, etc.) further reducing the delivered cost of a deployable cargo to a next location. High utilization rates for logistics assets, especially when the autonomous vehicle (as per prior inventive systems) itself is reconfigurable further enables seamless interchange between deployable cargo delivery and passenger travel throughout the multi-modal network of assets. Point to point logistics of all experience types are elevated to a level that far exceeds the individual ownership model of logistics assets and/or non-shared resources, in addition to a substantial accompanying cost reduction throughout the ecosystem.

The inventive system demands the feedforward control system features to continuously optimize network/fleet/asset performance including service assets, deployable assets, re-queueing assets and assets delivered within deployable cargos. Therefore, the incremental burden of supporting dynamic addressing is negligible not to mention the complexity burden is performed by reconfigurable asset system for dynamic reconfiguring of deployable assets with geolocation specific task allocation in an autonomous and automated manner (with individual, non-coordinated, and non-reconfigurable tasks, as known in the art). The further inclusion of a dynamic addressing allocation system being a f(t), whether fixed-firm scheduling from the fixed schedule database or feedforward schedule database accounting for parameters within the statistical probability projected database for scheduling shifts from a physical location assigned for a real estate asset location to an individual person (or cluster of persons) such that a DC delivery next location is linked to that individual person's next location as a f(t). Such a highly responsive system having the dynamic addressing capabilities enables the delivery of a deployable cargo ultimately designated for use by the individual person (also understanding this can be a designated group of people including a family or any individual person capable of receiving for the designated group) to respond to real-time variations of preferred addresses that converge between the predicted or specified individual person address with the address for the deployable cargo as determined by dynamic addressing.

Virtually any DC delivery preferably utilizes dynamic addressing allocation system such that physical location of the next location varies throughout the lifetime of the DC. In fact, even the ownership/responsibility of any given DC also dynamically varies throughout the lifetime of the DC. The inventive inclusion of the dynamic addressing allocation system as f(t) varies from a next SR Station to a next autonomous vehicle, to a next deployable asset including trailer, to a next deployable cargo, and finally to a next location recognizing that the linking of the DC to a specific real estate physical location or an individual having a dynamic next location as f(t) transitions throughout the lifetime of the DC within the inventive ecosystem. The SR Station reconfiguring is based on either a fixed-firm next location or the dynamic addressing system as f(t) such that a sequential next location switches between a specific next location, a next location represented by a geofence, or a range of next locations varying as f(t) based on dynamically varying functionality that can be performed at down-selected list of next locations from within a location candidate set. Furthermore, the system utilizes a dynamic pricing system in addition to dynamic positioning whether it be for itemized logistics prices for a deployable cargo delivery or an aggregate price for acquisition of product or service as delivered by the deployable cargo further including logistic prices, or even dynamic pricing system as f(t) based on an aggregate utilization of the logistics ecosystem within a membership service fee business model.

The dynamic pricing system is at least in part based on real-time actual (or projected f(t)) availability of capacity (autonomous vehicle, trailer, deployable asset) with a fundamental operating principle that capacity effectively has a value expiration time (i.e., once the vehicle begins its routing schedule) for any spare capacity in each leg of the journey (i.e., vehicle routing and SR Station) loses all value. The dynamic pricing system further includes bundle pricing for forward logistics tasks and reverse logistics tasks provided, and not solely unit shipping of an individual deployable cargo delivery. Membership fees preferably also utilize dynamic pricing system ranging from fixed pricing based on aggregate of purchases over a range of time, or preferred the utilization of shared resources over a range of time. A particularly preferred dynamic pricing system is for the membership model where an individual member (member, person, people are used interchangeably) (or cluster of members) have individually owned assets that are provided into the network inventory control database as f(t) at which time the respective individually owned non-deployable assets switches to a network/fleet of shared resource deployable assets (recognizing that the delivered equipment by the deployable cargo can revert back to an individually member owned non-deployable cargo) such that the dynamic pricing system is based on the fractional time the asset is retained as an individually owned non-deployable cargo compared to a network shared resource deployable cargo (deployed to member within the membership user pool, whether the user is a stationary user or a mobility user).

The variability of autonomous vehicle, trailer, and even deployable cargo demands the variability of docking position for a docking port of deployable cargo to enable the automated physical connection via the docking connector of the deployable cargo at the next location's docking position of the receiving docking port at said next location. This variability can be attributed to a wide range of conditions as accounted for by the dynamic height adjustment system for tire pressure of the trailer or autonomous vehicle, whether that be attributed to a slow leak or weather/temperature variability in addition to tire temperature due to travel time, distance or road conditions. The dynamic height adjustment system also accounts for snow or ice accumulation at said next location. The inventive system accounts for all these variations in performing a pre-positioning system of the docking connector by the docking mechanism for the docking port(s) of the deployable cargo (preferably upstream of the next location, particularly preferred upstream of the placement of the deployable cargo on the trailer, specifically preferred upstream of the placement of the deployable cargo on the autonomous vehicle or trailer, and precisely preferred within the SR Station in which the deployable cargo is presently located at, therefore less physical movement (at least 5% less, preferably at least 10% less, and particularly preferred at least 50% less) is required for final positioning and alignment at the next location for docking at the next location docking port.

Additional variability of the inventive system is due to projected (i.e., not originally accounted for) increases in capacity requirements at the next location such that additional deployable cargo is required in addition to the already present deployable cargos at that next location. In this embodiment, the SR Station reconfiguring takes place by the reconfigurable asset system and pre-positioning system for its respective next location's docking port(s) so that the to be delivered deployable cargo docks at a docking port having docking receiving capacity.

The inventive system has both a pre-positioning system docking port alignment system at the SR Station, in addition to either a second positioning docking port alignment system onboard of the DC (preferred due to higher utilization rate) or on-site (i.e., stationary) at the next location. The pre-positioning system docking port alignment system achieves alignment requirements of at least 50% of the physical movement, preferably at least 80%, particularly preferred at least 90%, and specifically preferred at least 95% of the physical movement required to achieve the actual physical docking at the next location. The preferred second positioning docking port alignment system to be performed at the next location requires a physical movement of less than 1 foot, preferably less than 6 inches, particularly preferred less than 3 inches, and specifically preferred less than 1 inch. In other words, the first positioning docking port alignment system has a higher freedom of range movement, by at least 3 inches (preferably at least 6 inches, and particularly preferred at least 1 foot) as compared to the second positioning docking port alignment system.

The inventive system further requires a reconfiguring (including swapping) of docking port docking connector mating system to accommodate the coupling via physical communication between the deployable cargo at the next location and the next location's receiving docking port(s). The assigned and reconfigured docking connector mating system is selected based on the specific combination of deployable cargo in its position for use at the next location and the next location's receiving docking connector mating system within the next location's receiving docking port actual position. This requirement may optionally require a change in assigned deployable asset or trailer in which deployable cargo is contained and transported or even assigned trailer in which the module having the deployable cargo is within, or assigned autonomous vehicle to safely and effectively transport the assigned trailer in which the assigned deployable cargo is contained within. Therefore, the inventive system utilizes down-selection process for each of the sequential processes of down-selection of autonomous vehicles or other deployable asset candidates including trailer candidates, all preferably based on the creation of a list of deployable cargo deliveries to a set of next locations and SR Stations (or intermediate staging stations, whether it be solely for the purpose of staging a subset of deployable cargo deliveries within the same deployable asset in which they arrived or for the purpose of using the SR Station reconfiguring of the deployable cargo, or simply to transfer the deployable cargo from a first deployable asset to a second deployable asset at a subsequent time to execute the designated deployable cargo deliveries). The preferred assigned deployable cargo delivery schedules leverage the feedforward control system as detailed earlier to achieve the highest potential utilization rate of logistic assets and to minimize excess spare capacity.

One embodiment of the feedforward control system is the repurposing of a deployable cargo as an energy storage device. In an exemplary instance of Pine Ridge indigenous community of Kyle and an exemplary counterpart community near Mt. Rushmore (both in South Dakota) the prior has heavy energy requirements for residential heating during the winter while the latter has heavy energy requirements within the hospitality industry during the summer tourism season. Both instances preferentially require the placement of stationary stored electricity within an energy storage device, but the dynamic placement of these energy storage devices between these two locations significantly increases the utilization rate of the energy storage devices as compared to solely stationary mode of required energy storage devices to meet each of the peak demand for the energy demand profile at both Kyle and Mt. Rushmore. The SR Station clearly needs to reconfigure the trailer for delivery of the deployable cargo as energy storage devices where the individual residential requirement is less than 20 kWh per day (all in different locations) as compared to the hospitality location (a single location) requiring over 200 kWh per day. Additionally, deployable cargo energy storage devices used in the winter at Kyle for stationary residential power requirements can alternatively be reconfigured first from a vertically oriented module into a horizontally oriented module to be used in tourist rental cars or buses (i.e., changing from a stationary user to a mobility user). Furthermore, weather variability even in the winter can leverage the SR Station to reconfigure the trailer for Kyle to include a second type of energy storage device such as thermal energy (as compared to electrical energy a.k.a. battery) concurrently with the delivery of electrical energy storage device with subsequent pre-positioning system of each of the respective docking ports to be within 6 inches of the docking port position at the next location to serve the designated residence in Kyle. The residences within Kyle, an especially rural location, leads to substantial variations in dock docking positions for each residence therefore requiring pre-positioning system of the docking port on the deployable asset to enable automated docking connector at the docking ports for energy transfer communication between the deployable cargo and the host residence at the next location. Furthermore, the voltage requirements between Kyle residences and Mt. Rushmore hospitality locations optionally demand a different docking connector mating system in which the SR Station reconfigures the module and/or deployable cargo to the appropriate type in addition to pre-positioning system to the appropriate position.

The pre-positioning system position for docking connector mating system includes dynamic alignment information based on the stationary receiving energy storage device size and docking connector mating system at the docking port to the traveling trailer as f(traveling trailer physical parameter set, location within traveling trailer the correct receiving energy storage device size and docking connector for respective docking port, receiving energy storage device size and docking connector, receiving docking connector mating system including physical parameter set for alignment), and selection of receiving energy storage device size and docking connector from within trailer based on current and future locations.

A preferred embodiment of the SR Station is further reconfiguring of the vehicle also in a highly automated and modular manner, such that the vehicle utilization is maximized by maximizing the vehicle reconfigurability leveraging the same automation equipment for the movement of at least one of DC or trailer movement with reference to vehicle enabling the same vehicle with inherently swappable DC (including energy storage device DCs serving onboard energy requirements and not solely off-board energy requirements of a next SR Station or next location). Changing the trailer includes reconfiguring analogous to the changing of a functional top hat, which within the context of a vehicle platform generally includes the upper bodywork, interior, and exterior of a vehicle. The particularly preferred reconfiguring of the vehicle, takin place at the SR Station, is limited to a trailer that varies only the vehicle interior of the vehicle for the purpose of vehicle functionality whether that be DC delivery or in-transit functionality is 1) movement of people (e.g., clients, passengers, employees); 2) charging of onboard energy storage device DCs leveraging a second onboard power generation system (e.g., internal combustion engine, external combustion engine, solid-state electrochemical power generation), or 3) discharging of onboard DCs for in-transit vehicle energy demand profile. The specifically preferred reconfiguring of the vehicle has energy storage device DCs for onboard energy consumption within an interchangeable module (that as per previous patent application filed) that is further interchangeable in terms of DC as energy storage device with respect to type, size, capacity, etc. that is further within an interchangeable trailer; and the trailer is swappable within a fixed upper bodywork and vehicle exterior. The particularly preferred upper bodywork and vehicle exterior is standardized across the entire fleet of vehicles within the inventive system or at the minimum enables changing of at least one of standardized deployable assets and/or trailers. Standardization of the upper bodywork and vehicle exterior is particularly important for autonomous vehicles as the cost of systems required to make the autonomous vehicle can in many cases become more expensive than the vehicle itself, especially when energy storage devices (including range extender power generation system with fuel) are capable of being removed, resized, etc. (i.e., reconfiguring), and particularly when electric motors (including conversion of two-wheel drive to four-wheel drive and vice versa) can also be removed, resized, etc. (i.e., reconfiguring) from the vehicle. In this manner, the vehicle becomes truly a standardized deployable asset itself really being a container within a container, etc. The best-known example of this is shipping containers (i.e., standardized) that are moved via rail or ship (i.e., standardized containment/docking), etc. though having a severe limitation of essentially a single size and decades of standardization. The inventive system using active reconfiguration leveraging the dynamic feedforward control system with proper automation systems for reconfiguration handles the complexity across the ecosystem without requiring multiple industry standardization adoption and/or forcing massive retrofit to existing systems. Utilizing the inventive system for the primary purpose of demand reduction within a behind-the-meter electric infrastructure provides compelling economics such that other use cases can follow yet leveraging the economics of scale (and very high volume of forward logistics tasks and/or reverse logistics tasks) achieved from the electric utility market. To put it simply, the massive investment associated with consumer autonomous vehicles has substantially subsidized the utilization of those control systems into multiple other non-anticipated use cases.

Dynamic height adjustment system—The upper bodywork and vehicle exterior are in structural communication with the pre-positioning system that is further in structural communication with the docking connector mating system. The SR Station is operational for reconfiguring of the height of the trailer by the dynamic height adjustment system on the vehicle as a further controllable variable of the pre-positioning system to enable proper docking at the next location (or next SR Station particularly when the next SR Station is not equipped with the trailer dynamic height adjustment system capability, such as for a smaller less functional SR Station where reconfigurability could be limited to changing deployable cargo within a trailer, or changing of a trailer but not the trailer height on the vehicle). It is a fundamental objective of the invention to distribute and decouple the actuators (i.e., docking mechanism) away from the next location to the largest extent possible, especially when the next location has a relatively low frequency of DC deliveries. This is done by integrating required actuators into the SR Station, such that the vehicle requires less actuators to achieve the same precision docking at the next SR station or intermediate staging station as compared to integrating the actuator performing the trailer height adjustment either within the vehicle, the trailer, or stationary at the next location. This decoupling of actuators is also relevant for other axis degree axis degrees of freedom motion required for alignment/docking of the trailer to the next location as per a distributed docking mechanism system.

Distributed docking mechanism system performs at least one axis degrees of freedom motion alignment at first location (e.g., SR Station) (highest precision requirement preferred) and at least a second axis degree of freedom motion alignment at a second location (e.g., next location). Clearly the SR Station as the first location has a higher utilization rate than the next location as the second location. The preferred distributed docking mechanism alignment system (and even the dynamic height adjustment system) utilizes an actuator that integrates an at least two axes compliant mechanism. The particularly preferred compliant mechanism has at least one axis degree of freedom motion of the compliant mechanism with an open face (i.e., concave) in reference to the docking connector at the docking port at the next location.

The utilization of an external system reconfiguring a vehicle therefore requires an external system to identify critical physical parameters of the physical parameter set that alter the vehicle performance, that is particularly useful and easily utilized when the vehicle is an autonomous vehicle. Furthermore, the inventive system can readily alter the vehicle's routing accounting via dynamic routing system for any restrictions that result from changes in the vehicle's center of gravity, weight, height, width, range etc. This decision making can become bi-directional and therefore a feature of the feedforward control system such that SR Station prevents deployable assets or deployable cargos (or any combination thereof) that exceed or overburden the vehicle to meet its designated routing. The SR Station at a minimum communicates to the specific vehicle being reconfigured the minimum set of parameters required to ensure successful docking at the next location, which includes the docking angle, distance, and height relative to the next location's dock receiving system. The preferred SR Station also communicates to the specific vehicle being reconfigured the minimum set of parameters including the vehicle's center of gravity, weight, height, width, and range such that the vehicle movement control system utilizes those parameters to dynamically alter operating envelope of the vehicle by the vehicle movement control system with respect to the vehicle acceleration and deceleration control parameters to ensure safe vehicle and/or trailer operations (which can be optionally as a function of the route itself such as setting maximum speed or turning angle threshold in addition to as a function of actual position within the route yielding dynamic vehicle movement parameters resulting in routing based in-transit restrictions). Reconfiguring of the vehicle as anticipated by the inventive reconfigurable asset swapping system is significant as the transport of deployable cargos especially when the deployable cargo is an energy storage device, again recognizing that varying the amount of energy storage devices on the vehicle is also anticipated to dynamically reflect the energy demand profile for the upcoming vehicle routing as established by the dynamic routing system prior to reaching a next location where this next location can provide either charging capacity or swapping of energy storage devices, substantially changes (by at least 1 percent, preferably at least 5 percent, and particularly preferred at least 20 percent) the vehicle's at least one parameter of the physical parameter set for the vehicle (most importantly the center of gravity). Dynamically reconfiguring the vehicle is particularly important, and anticipated, where the vehicle routing is weight capacity limited, therefore any removal of unnecessary energy storage device deployable cargo enables additional non-energy storage device deployable cargos on a direct weight swapping basis (i.e., every kilogram of unneeded energy storage device enables an additional kilogram of deployable cargo to be carried).

Another embodiment of the invention utilizes a DC or deployable asset reconfigurable asset system for the physical Docking Connector that enables transfer between the DC(s) and the next location via their respective docking port(s). This reconfigurable asset system is preferably integrated into the pre-positioning system at the SR Station such that the deployable assets and DCs reconfiguring meets the operational requirements of the next location(s). The reconfigurable asset system and it's pre-positioning system establishes the position within the pre-position docking envelope (i.e., the position of the docking connector) of any DC as a function of f (position for docking at next location docking port, i.e., stationary docking position, for proper transfer from DC to next location required to execute its operational function, docking connector type for docking at the next location enabling proper docking understanding that the projected DC/trailer position may be at an angle/distance away from the next location docking port therefore requiring a docking connector having flexibility and length to make up for the anticipated failure of a direct physical connection without a docking connector). The docking connector can also be a function of f (size requirement for next location's docking position for active use though also having additional constraints specific to in-transit routing restrictions, intermediate resequencing at a next SR Station, reconfiguring for next locations, in-transit trailer restrictions, or in-transit vehicle restrictions) including the requirement to prevent discharge of DCs when they are stored energy that could be attributed to vehicle road conditions. The system's pre-positioning system or pre-configuration systems takes into account reconfiguring requirements due to deployable asset, trailer, or deployable cargo changes attributed to variation of time of day or seasonal, or even an event specific set of requirements.

The SR Station triggers the communication between the SR Station and the next location's dock receiving system indicated at the minimum reconfiguring parameters of the vehicle/trailer/deployable cargo such that proper docking takes place at the next location. The next location has a docking receiving capacity and docking receiving system that at a minimum provides pre-positioning system parameters of the vehicle/trailer/DC to ensure successful docking. As noted earlier, the pre-positioning system at the SR Station at least accelerates the docking time at the next location and most importantly enables the preferred automated docking between the vehicle/trailer/DC docking port(s) to the next location's docking ports via the dock receiving control system. Parametric information transfer includes conveying the trailer object id and parameters within its physical parameter set, deployable asset's object id and parameters within its physical parameter set, and DC(s) object id and parameters within its physical parameter set. The SR Station preferably communicates to the next location any pre-positioning system instructions for any actuators at the next location such that the pre-positioning system instructions moves actuators of the docking system at the next location in advance in order to reduce the docking time by providing instructions specific to the vehicle's parameters docking at the next location. The SR Station (understood that communication channels can be any known in the art wired or wireless methods, including relayed or triggered communication channels such as the internet, the next vehicle arriving at the next location though in advance of arrival) preferably also communicates to the next location via two distinct communication channels such that the vehicle and the next location (including also when next location is a next SR Station or intermediate staging station) achieves multi-factor multi-channel authentication preventing any unauthorized transfer from the vehicle, the trailer, the deployable asset or the DC to the next station which is best realized by having both the next ST station or intermediate staging station and the vehicle's respective docking system. Preventing a successful docking from being completed, except for already successful multi-factor multi-channel authentication verification, also further limits the capability of unauthorized transfer of deployable cargos.

Though not preferred, due to low utilization rates, the vehicle, the trailer, the deployable asset or the next SR station or intermediate staging station has an optional post-parking docking system to overcome any shortcomings due to non-optimal or failed docking that otherwise limits the successful transfer of the DC at the next location. The post-parking docking system is preferably configured with a compliant mechanism between the respective docking ports. The particularly preferred post-parking system utilizes its compliant mechanism to dock with at least one of the vehicle, the trailer, or the DC's docking port, or the next location's docking port also having a compliant mechanism, specifically preferred with the next location docking port's compliant mechanism having freedom of motion on a different axis (e.g., Y or Z direction) than the post-parking compliant mechanism's freedom of motion axis (e.g., X direction). The presence of the post-parking docking system, despite its lower utilization rate as compared to pre-positioning system at the SR Station (preferably utilization rate differential greater than 5 percent, particularly preferred greater than 20 percent, and specifically preferred greater than 80 percent) enables substantially different deployable cargos, in terms of docking specifications variables of a next location. to bypass a next SR Station requirement (or intermediate staging station) to vary the at least one of the vehicles, the trailer, or the DC pre-positioning system or change in docking connector thus avoiding an unnecessary reconfiguring stop in addition to maximizing routing flexibility. It is understood that a next location that transitions from a low-frequency to a high-frequency (at least relatively, in which a common financial return on investment assessment can be made) docking occasion location can justify the placement of a post-parking docking system to be permanently located at the next location (or to integrate the post-parking docking system into either the vehicle, the trailer, or the DC.

The SR Station reconfiguration system contains a control system that selects from the current SR Station inventory DCs, when orientated properly within the deployable asset (or trailer when used), that have the same height (or at least a fraction of the same height such that other DCs from within the inventory when stacked on top of each other) such that a stacking inter-layer is flat (at least when in the active operating mode of the DC, such as an electrical energy storage device i.e., battery). Furthermore, when more than one DC can fit within either the length or width of the deployable asset (or trailer when used) DCs having the same length and width are selected from the SR Station inventory (or at least a fraction of the same length and width combination such that other DCs from within the inventory for stacking side by side). The inventive stacking layer, particularly when used in between DCs that are energy storage devices, are configured with physical communication channels enabling at least one of series or parallel sequencing between stacked layers of DCs, preferably also with integral switching between active or isolation mode (such that during transport no inter-layer transfer can take place), and particularly preferred such that the stacking layer has integral switching between series, parallel, and isolation mode. The preferred embodiment of the SR Station reconfiguration loads the DCs within the deployable asset or trailer from top of the deployable asset or trailer, even if the ultimate DC orientation is changed from vertical (i.e., relative to the top) to horizontal during vehicle transit. A particularly preferred stacking layer is provided during the top loading in a deflated mode for loading and unloading of the DCs within the module or trailer (but inflated for loading and unloading of the module or trailer from the vehicle) and then inflated to secure DCs with respect to any bus bars within the module or trailer having thermal and electrical conductivity communications. It is understood that the aforementioned modes of deflated mode and isolation mode are including in the physical parameter set. A specifically preferred bus bar connection of the deployable asset (or trailer) has a receiving portion (relative to the DC) that is both flexible and concave whereas the portion of the DC that then mates with the module bus bar as a counterpart that is rigid and convex. In other words, the module bus bar has individual flexible concave portions that mate with the DC(s) rigid convex portions enabling transfer between the module and DC. It is understood throughout this invention that multiple DCs can be within a deployable asset or trailer. Furthermore, that the vehicle can load or unload a trailer, a module (an aggregate of DCs), and at least one DC such that any reference to a DC docking can in fact become a module docking or even a trailer docking such that the key feature is such that a deployable asset is able to transfer its deployable cargo contents as moved via a vehicle from a first location to a next location at the next location.

The inventive SR Station reconfiguration system enables a broader ecosystem to leverage truly shared resources especially in the preferred embodiment of standardized sizes (including fractional nesting of individual deployable cargo that fit firmly in an active operational mode within a module) by utilizing standardized fractional sizes. The particularly preferred embodiment further integrates standardized docking connector types for maximum utilization via reconfiguring at SR Station to enable automated docking between DC and deployable asset, or deployable cargo and trailer, or between deployable cargo and docking connector at the next location's docking port(s).

The inventive feedforward control system stages the placement of DCs, modules, trailers, and connectors to reduce the placement of relatively high-cost assets that become underutilized due their “permanent” hosting within an underutilized asset. It is known in the art of swappable batteries between vehicles are designed around the same readily interchangeable battery packs, as their purpose of such swappable battery systems is predominantly if not solely to reduce vehicle idle time due to electrical charging of the batteries. Battery swapping stations of that type/purpose are utilized extensively in on-road transport vehicles (e.g., semi-trucks) or off-road vehicles (e.g., forklifts within a warehouse) but those are both instances in which the host asset utilization rate is high only when the vehicle itself has a high utilization rate of the entire battery pack capacity (in other words, the swapping of a large battery pack for a short trip is wasted battery capacity and even worst potentially reduced freight capacity). Passenger vehicles, airport ground support, maintenance or installation service vehicles (e.g., HVAC/R repair, cable-TV, postal delivery, last-mile delivery trucks such as UPS, USPS, FedEx) are all low utilization vehicles (less than 80 percent, many less than 60 percent, and most less than 50 percent on a time basis). In which case the electrification of everything movement is leading to a transition to electric vehicles, such that especially when considering range anxiety (even though full range capability is very infrequently used) the extra burden of underutilized energy storage devices creates economic and operational disadvantages associated with excess weight and low utilization factor capital cost of energy storage, all translating to higher capital and operating costs. A fundamental feature of the SR Station (it is understood that any reference to ST Station can also refer to intermediate staging station) is such that the SR Station itself can be dynamically repositioned to minimize DC transport time and/or distance such that energy storage devices are decoupled from their place of discharging (e.g., host vehicle or next location). Therefore, the inventive system utilizes dynamic addressing for each deployable asset and deployable cargo within the reconfigurable asset system, such that dynamic placement of SR Stations, modules, trailers, and DCs are optimized for utilization rates by leveraging standardization to the largest extent across the entire ecosystem of host vehicles, host trailers, host modules, next locations and next SR Stations. And dynamic pricing, as determined by the dynamic pricing system, is now decoupled from logistics by incorporating transport as a function of actual distance and/or time traveled as only required such that the system is priced on total cost of delivered value (including product, service, and/or logistics) as operating energy costs, cost per distance unit, cost of “fuel” per distance unit lose context as the shortest distance traveled is not very often leading to the lowest cost of delivery.

### Mobility User “Vehicle”

The preferred embodiment of the vehicle utilized within the reconfigurable asset system leverages a standardized module for at least two deployable assets of the energy storage device DC, deployable seating DC, product DC, deployable motor DC, and power generation system DC. A more preferred embodiment leverages standardization between modules and trailers. And the particularly preferred embodiment leverages standardization amongst DCs, modules, and trailers. Maximizing the utility of this invention further requires reconfigurable docking systems between the vehicle (or trailer, or module, or DC) all of which are mobility assets) and stationary assets (or optimally have dynamic placement for at least periodic stationary functionality via dynamic addressing) for automated and seamless transfer of asset from mobile assets to stationary assets (and vice versa) ecosystems.

The ability of the vehicle to have altered and reconfiguring modules, particularly between product logistics functions and personal travel functions requires a vehicle exterior that can readily change shape. The preferred embodiment of the vehicle has at least one compliant mechanism in structural communication with the vehicle exterior to shift between a high-profile height (i.e., taller interior cabin) and a low-profile height (i.e., shorter but longer interior cabin). The particularly preferred embodiment of the vehicle has the compliant mechanism to morph the vehicle exterior position to reduce both aerodynamic drag and the transmission of noise (attributed to airflow as a function of vehicle velocity) generated into the vehicle transporting passengers (i.e., personal travel). The specifically preferred embodiment of the vehicle has the compliant mechanism positioned within an exoskeleton of the vehicle, and physically away from the passengers' viewing window(s). The compliant mechanism can transition to a third shift of vehicle exterior for easier passenger loading or unloading, which in most embodiments further increases the vehicle's profile height including a taller vehicle interior passenger cabin.

The compliant mechanism of the vehicle can make another shift of vehicle exterior for reconfiguring to vary the asset cargo capacity (another parameter of the physical parameter set). It is understood that the compliant mechanism, can also be of any asset including modules or trailers, is preferably in physical communication to an exoskeleton of the asset. In this manner the exoskeleton serves as a crash protection barrier to deployable cargo and its the contents, while also enabling reduced asset length when the maximum asset cargo capacity is not required. Understanding that non-personal DCs most often require substantially lower environmental isolation the ability to structurally morph to a larger length profile is accompanied by lower environmental barrier demands. Dynamic reconfiguring of he vehicle between an energy storage device deployable cargo and a product deployable cargo enables a vehicle that otherwise requires a significant energy storage device energy storage capacity (whether to meet actual range requirement until the next swapping with reconfiguration station or intermediate staging station having energy storage capacity in which energy storage devices deployable cargo are swapped into the deployable asset or simply range anxiety when transporting people) to morph into a vehicle that can transport additional DCs by reconfiguring vehicle interior space to readily meet the requirements of the additional non-energy energy storage device deployable cargo.

The inventive vehicle's vehicle movement control system automatically adapts its interior environmental control as a function of SR Station communicated parameters of the physical parameter set specific to the onboard DCs operating specifications in combination with the vehicle's exterior profile height configuration, including dynamic noise cancellation features as a function of the exterior profile height configuration when the deployable asset is transporting passengers.

A preferred embodiment of the vehicle distinguishes between deployable assets without passengers and further differentiates by passenger type such as passengers that are selected from a) employees of the company operating the deployable asset, b) clients of the company operating the deployable asset, or c) passengers with a specific membership type. The SR Station reconfiguring of the vehicle, as determined and modified by the reconfigurable asset system, is based on a combination of the time of travel for a passenger and the types of passengers specifically including the deployable asset having deployable seating to match the specification for the respective type of passenger. The particularly preferred reconfigurable asset system further combines with the available inventory as determined by the inventory control database at the present first SR Station as well as for the future next SR Station. The SR Station maintains an inventory of DCs that are interchangeable into the vehicle such that scheduling optimization further accounts for employee(s) beginning and ending of work-shifts (to forego an employee requiring other transporting means such as a personal vehicle or public transportation) to reduce the incremental cost of employee transit to or from a workplace. Many employees work at companies that have their own internal logistics requirements (or in proximity to other companies or institutions), many of which can be fulfilled by integration into a broader set of forward logistics task and/or reverse logistics task, therefore making a dynamic routing system capable of integrating not only the routing requirements for deployable cargos and deployable assets but also service tasks (e.g., transporting of people, particularly as noted employees, or virtually any consumer of industrial product as known in the art for logistics at large. The fundamental ability to switch DCs for a vehicle also enables the vehicle to coordinate concurrent delivery or retrieval of additional DCs timing to employee personal transit schedule requirements, notably energy storage, food, mail, and/or clean dishes or laundry delivery at their residence. A DC that itself is reconfigurable with integral collapsible seating (a hybrid of deployable seating) is perfectly suited as deliveries of product(s) also with integral collapsible shelving enables a seamless transition post-delivery of deployable cargo from a cargo mode (optimized for carrying deployable cargo) to a passenger mode (optimized for carrying passengers) or vice versa. The SR Station and feedforward control system differentiate between employees, clients, and passengers as employees and their employers (especially when paid for any additional incremental transit time, though best when the employees respective employer connects wirelessly with the employee to perform remote-capable work tasks) are then more tolerant to additional transit time such as occurring with otherwise intermediary stops at additional non-related next location(s) or next SR Station(s). To this end, the dynamic routing system adds intermediary stops including stops at swapping with reconfiguration stations and/or intermediate staging stations between the time an employee enters and departs the deployable asset. Clients and/or non-employee passengers are differentiated from employee passengers such that the SR Station sequences the vehicle routing with a highly minimized (preferably at least 25 percent less, particularly preferred at least 50 percent less, and specifically preferred at least 80 percent less) number of intermediary stops between the time a passenger or client enters and departs the vehicle as compared to intermediary stops for employee passengers, and also configures the vehicle when available from inventory a DC with more comfortable seating from a DC outfitted with employee seating. The added time required to transit to the additional stops, as compared to direct transit between the otherwise non-stop trip, is designated as excess transit time.

Another embodiment of the inventive system is the dynamic addressing deployment of a SR Station to a place of work particularly at the end of shift times (though also reasonable at beginning of shift times) preferably with concurrent vehicle(s) having DCs for employees as a method of bypassing the requirement for a separate delivery task schedule specifically linked to the employees ending their shift. In the event of the SR Station utilization for the beginning of shift times the methods of transit utilized by arriving employees preferentially have DCs that become reconfigured at the SR Station by the reconfigurable asset system at the employees' workplace. Yet another embodiment, which is specifically preferred, is the vehicles utilized by arriving and departing employees are themselves shared resources in which the vehicles are reconfigurable.

Reconfigurable mobility users and/or deployable assets are uniquely dependent on SR Stations preferably SR Stations that are automated in functionality for reconfiguring at least one of vehicle, deployable asset, trailer, module, or deployable cargo. A system with a fleet of deployable cargos and SR Station assets having a fully electrified infrastructure fundamentally drives down the variable cost of transit operations, especially when the fleet of DCs are moved by properly sized (i.e., multi-modal) vehicles, to less than three percent of delivered value (and preferably less than 2 percent, and particularly less than 1 percent of delivered value). The variable cost reduction of transit operations to a negligible portion of delivered value transitions from feedforward control optimization to maximum asset utilization, which also drives the amortization allocation of fixed costs to a negligible portion of delivered value.

Under the scenario of logistics (whether it be product or people) being driven to a negligible portion of delivered value, the inventive system empowers new business models across multiple domains. The earlier mentioned provision of employers providing employees with free or highly subsidized transit to/from their workplaces becomes a truly meaningful financial benefit to employees, as personal vehicle ownership is very often utilized for work commuting. Furthermore, the utilization of personal vehicles for work commuting is virtually always a major contributing factor of lower utilization for those personal vehicles (i.e., the vehicles are parked for their entire work-shift, with the possible exception of lunch breaks) Sustainable communities can easily leverage shared resources from transit vehicles to tools, deployable energy providing assets, and even deployable air conditioning and heating assets. A network of sustainable communities designed around shared resources can easily utilize SR Stations to enable even long-distance movement of shared resource assets between hemispheres such as air conditioning following the summer season at a first location and heating following the winter season to a second location. The optimal sustainable community design utilizes the SR Station(s) to remove low-utilization rate consumer appliances from individual residential units into high-utilization rate industrial appliances (e.g., dish washers, laundry, outdoor grills, etc.) further reducing the aggregate capital costs within the community therefore driving down the cost of living for its residents. As noted before that the SR Stations are utilized for behind-the-meter movement of energy storage device assets (both electrical and thermal), a sustainable community can even transition from an individual residential-scale to an industrial-scale (having superior energy efficiency ratings) HVAC and domestic hot water heaters. This results in superior community energy efficiency coupled with lower utility costs.

### Trailer

The continuous variability of DC parameters from the physical parameter set (e.g., types, quantities, and weight plus the additional variability of docking conditions) leads to a large variability of aggregate in-transit size requirements, weight and size. As such the reconfigurable asset system dynamically varies transit and delivery schedules using both a feedback schedule database and schedules within the fixed schedule database (i.e., based on current inventory levels of trailers and modules within the SR Station) and feedforward schedule database (i.e., based additionally on future predicted inventory levels, delivery requirements of next SR Stations and next locations for the respective next SR Stations). The SR Station in this manner recognizes that a vehicle routing, frequency of utilization, and spare asset cargo capacity within the vehicle enables flexibility of trailer size and most importantly flexibility of placement of modules and DCs within the trailer. The SR Station further places the trailers, modules, and DCs within the vehicle position based on maintaining safe operations of the vehicle (vehicle parameter of physical parameter set such as center of gravity). The inventive trailer has a dynamic center of gravity positioning system integral to the preferred trailer that particularly accounts for variable asset cargo capacity within the deployable asset. The particularly preferred dynamic center of gravity positioning system has an integral compliant mechanism to minimize the movement required by either an onboard actuator or an off-board actuator of the SR Station.

The noted variability of trailer size, number of modules and DCs within the trailer requires a dynamic and flexible busbar (another parameter within the physical parameter set) to enable proper transfer between aggregate trailers within a vehicle, aggregate modules or DCs within the trailers, and aggregate DCs within modules or even aggregate DCs directly within the trailer. The movement of stored energy substantially benefits from a flexible busbar to provide continuity of electrical or thermal conductivity. Flexible busbars are known in the art, yet these busbars do not inherently support dynamic or frequent connection and disconnections of the objects that in physical communication with the busbars and certainly not the frequent connection and disconnections of an entire set of objects. The particularly preferred flexible busbar has an integral compliant mechanism or compliant material producing a homogeneous pressure (another parameter of the physical parameter set, preferably pressure within plus or minus 50 psi, particularly preferred within plus or minus 10 psi, and specifically preferred within plus or minus 2 psi) between all objects that are in conductivity continuity with the busbar. The specifically preferred busbar has a hollow chamber within the compliant mechanism or compliant material capable and optionally (preferred) capable of being charged or discharged of fluid or air (i.e., inflatable). The busbar also has an optional orientation and non-conductive portion that serves as an alignment rod for components that are placed into the trailer, module or DC. The busbar optionally can be segmented and reconfigured by rotation to enable physically adjoining of connected objects (or at least one) in order to switch (by rotation) from a series or parallel connection relative to the other connected objects.

The trailer is configured as a function of f(DC(s) @ next location 1, @ next location 2, . . . @ next location n) such that trailer, module, and/or DC swapping is a feature of the system. As noted earlier, it is understood that compatibility amongst locations is critical from a docking perspective especially for DCs that are automated in terms of transfer between the DC and the docking port at the respective next location(s). Furthermore, it is understood that additional energy storage capacity, when the deployable cargo is an energy storage device, can be provided in a first location such that the DC can avoid a next SR Station before meeting the requirements of a second location (i.e., next location after the first location) by exceeding the energy storage capacity requirements of the first location such that the first location receives stored energy sufficient for both the first location and the second location. Avoiding an intermediary SR Station requires a common Docking Connector for both the first location and the second locations.

### Docking Connector

The preferred position of the docking connector for a DC (as well as DC to module, DC to trailer, and DC to DC) is on the top of the DC (or respectively other components), and preferably in a nested position within the top of the DC such that DC stacking can take place independent of the docking connector position. The particularly preferred docking connector is a compliant mechanism in which the active position height enables protrusion through any stacking layer (in fact the docking connector can be integral to the stacking layer, such that an actuator on the perimeter of the stacking layer enables movement from the active to retracted position interchangeably). A specifically preferred DC has a second set of docking connectors on the bottom of the DC (again nested within the bottom of the DC) enabling the DC to host trailer or host module or to bottom adjoining second DC interconnection. An optional preferred feature of the docking connector is integral switching of conductivity mode between series, parallel and bypass modes leveraging as known in the art wireless or powerline carrier communications.

The DC docking connector preferably mates with the docking port(s) at the next location, particularly preferred to be interchangeable with a standardized stacking layer, from the top of the DC. This embodiment of the stacking layer has integral guide rails on the perimeter of the stacking layer and preferentially has a physical barrier on top (relative to the guide rail when in the deployed position) serving as environmental and security barrier. The guide rails enable the delivering vehicle (or module or trailer) to move the docking connector into its active position such that physical conductivity (or energy/fluid transfer) can take place with the receiving docking port(s) at the next location.

The receiving docking port at the next location is preferably in structural communication with a building vertical wall (or mounted pole) at a height such that when moved into a horizontal position is within 1 foot (preferably within 6 inches, and particularly preferred within 1 inch) of the top of the DC when placed in its parking position at the next location. The vehicle (and/or trailer, and/or module) has a first camera that views the receiving docking port while in its vertical position such that the camera view provides feedback to the vehicle (or trailer) docking mechanism system, preferably such that a second camera view mounted on the receiving docking port also provides feedback to the docking mechanism system, and particularly preferred such that the vehicle mounted first camera and the receiving docking port mounted second camera is collectively combined to create a more precise relative position for a superior performing docking by the docking mechanism.

Utilization of the receiving docking port guide rails provides high-accuracy and precision movement on at least 1 axis degree of freedom motion for DC docking port to receiving docking connector of the docking port. The actuator moving along the guide rail can optionally have a second actuator providing a second axis degree of freedom motion. The third axis degree of freedom motion is along the height (Z axis, such that movement along the plain of the DC top has the X and Y axes). The particularly preferred actuator for X, Y, and Z axis degrees of freedom motion movement provides for a compliant mechanism to enable at least 2-axis degree of freedom motion alignment, preferably 3-axis degree of freedom motion (though the 3rd axis degree of freedom motion can be a non-compliant mechanism) for electrical or fluid docking connector types. When the receiving docking port lowers on to the top of deployable cargo top-mounted docking connector for docking port(s) the third axis degree of freedom motion alignment actuators create pressure by magnetic, pneumatic, or fluid actuator engagement (preferably powered by the vehicle moving the deployable cargo due to a higher utilization rate as compared to an actuator mounted on the receiving docking port, unless the receiving docking port is also a SR Station).

### Compliant Mechanism

The utilization of an at least one axis degree of freedom motion, preferably at least two axis degrees of freedom motion, and particularly preferred three axis degrees of freedom motion, with a compliant mechanism relaxes the precision requirements of docking the trailer, module or even DC to the receiving docking port(s). It is further preferred that the force across the compliant mechanism has the benefit of a homogeneous applied force to each of the docking ports, which as noted earlier is achieved by use of a dynamically controlled compliant material (preferably that is hollow such that a fluid or air fills a contiguous chamber in physical communication with each of the docking ports). The particularly preferred second positioning docking port docking mechanism system utilizes a compliant mechanism providing self-alignment along a first axis degree of freedom motion when the docking port moves along at least one second axis degree of freedom motion. Further the particularly preferred system utilizes a compliant mechanism for both the pre-positioning system docking port and the second positioning docking port.

One embodiment of the compliant mechanism is to engage at least one of the two energy storage device current collectors (i.e., energy storage device deployable cargo) to activate the battery pack for operations. The stacking layer can also be an inflatable “bubble” such that it creates a gap to isolate the battery current collector when in an inactivated mode and deflated (or reversibly inflated) above the current collector to create an even pressure across all battery cells from the current collector and outer skin of the battery pack.

### Chain of Custody Control

The inherent portability of the trailer, module, and/or deployable cargo therefore has inherent security (i.e., theft) flaws. Therefore, the inventive system preferably has multiple implementations of multi-factor and multi-communication channel authentications “MFA-MC” to maintain secure chain of custody control throughout the entire inventive ecosystem. The MFA-MC system uses at least one vehicle or trailer wireless communications method combined with at least one next location or next SR Station wired or wireless communications method for DC (and trailer or module) activation and/or deactivation, preferably where the inventive system further uses advance notification of GPS location as a function of time to provide yet another level of activation control. The MFA-MC also provides “unlocking” of the DC(s) from at least one of the vehicle/trailers and receiving docking port engagement. Ideally the DC is inactive during transit for both security purposes and to protect on-board equipment in DC during in-transit movement, especially isolation from vibration, etc. Particularly preferred is such that a pneumatic “pillow” of the stacking layer also serves as a vibration damper when in the inactivated position.

Fail-safe security due to unauthorized movement is also another feature of the inventive system such that a gravity drop instability bar (its position is another parameter within the physical parameter set) is released into its elongated fully extended position resulting from any unauthorized lifting of DC(s) (or trailer/module). Retracting the gravity drop instability bar is disengaged except after successful MFA-MC verification. The preferred gravity drop instability bar has multiple instability bars to make it more difficult for movement of DC, module, and/or trailer. Yet another embodiment of the MFA-MC is such that it provides external activation or physical engagement of the trailer, module and/or DC further comprised of transitioning retractable wheels (or alternatively though less preferred with wheel locks preventing rotation) to a fully extended position enabling case of repositioning movement. The MFA-MC also enables switching of docking port(s) from an inactive or locked mode to an active or transfer mode.

### Dynamic Routing System

The inventive availability of the SR Station, or more broadly reconfigurable trailer, module, and/or DC places substantial routing and scheduling complexity demands. The inventive feedforward control system places even more complexity beyond a traditional feedback control system. The feedforward control systems schedules via a dynamic routing system for the vehicles, modules, and DCs based on trailer and/or module compatibility with the vehicle and the receiving docking of next location(s), dynamic routing system of trailers based only on the next location compatibility including first next location functional compatibility (docking of trailer for loading/unloading and even compatibility of deployed DC(s), in addition to resequencing, staging for temporary repositioning to a second next location (i.e., passthrough), or reconfiguring DC(s) for subsequent use at a second next location).

The dynamic routing system takes into account forward logistics tasks (and preferably also reverse logistics tasks), and DC requirements at the SR Station or next location as f (client, employee, member rating, passenger) scheduled to utilize a specific DC. In other words, routing is NOT inherently the shortest or least expensive logistics (as measured in traditional logistics systems) as additional non-logistics priorities are preferably incorporated (such as enabling employee to perform workplace tasks i.e., service tasks while in transit)—client(s) logistics requirements have priority over employees logistics requirements (especially post work-shift), clients logistics requirements have priority over reverse logistics task requirements, and clients logistics requirements have priority over forward logistics task requirements when time sensitivity is not relevant.

It is further understood that logistics is susceptible to transit time deviations, from projected to actual, due to inaccurate predictions whether attributed to impossible to anticipate adverse events (e.g., other vehicle or current vehicle crash), weather, inherent variability of traffic patterns, and within the inventive reconfigurable asset system time variations associated with docking mechanism, reconfiguring vehicle (or trailer or module or DC), and also cascading variations due to the inherent dependencies on a DC not simply traveling from a single origination location to a single destination location further amplified by time variations associated with DCs potentially (likely) interacting with multiple modules, multiple trailers, multiple vehicles, multiple SR Stations, and of course potential (likely) passing through at next SR station(s). The time variation requires the inventive switch (dynamically and continuously) of the feedback control system and the feedforward control system such that the integration of the feedforward control system reduces aggregate logistics costs, reduces late (i.e., failed) arrival times prior to DC absolute time of use requirement at next location by repositioning interchangeable assets (i.e., vehicle(s), trailer(s), module(s), and even DC(s)) in order to avoid a late estimated arrival time or failure of the DC to successfully accomplish its specific function at the next SR station. The inventive system having high utilization rates across its asset classes further integrates either new or additional assets in reserve (positioned dynamically by the feedforward control system) to minimize the incidence rate of late arrivals by at least 2 percent (preferably at least 5 percent, particularly preferred at least 20 percent, and specifically preferred at least 50 percent) as compared to a logistics system entirely based on schedules within the fixed schedule database or schedules deterministic by only the feedback control system. Movements of reserve assets from a current location to a next location, especially when not absolutely needed (i.e., 100 percent certainty) utilizes the feedforward control system to accelerate scheduling tasks that are readily achievable along the feedforward control systems determined routing, which leads to reductions of future late arrivals by either completing the scheduled task(s) ahead of time (therefore impossible to be late) or reducing future transit distance (therefore lowering the statistical probability of being late). The feedforward control system utilizes the network of SR Stations by issuing new scheduling tasks for DCs (and their accompanying modules, trailers, and/or vehicles) in accordance with both asset cargo capacity as established by feedback control system availability as well as feedforward control system availability.

The reconfigurable asset swapping system within a network of swapping with reconfiguration stations specifically provides for dynamic energy storage capacity, docking receiving capacity, energy production capacity, etc, thus enabling the inventive system reconfiguring of traditional backup power generation system or backup energy storage device system (collectively referred to as backup power system) to have dynamic energy storage capacities. In this manner, the otherwise backup system has substantially higher utilization rates of power generation system and/or energy storage devices components. The same ability to achieve higher utilization rates for environmental systems is achievable. This is of particular importance for data centers, healthcare, and cold storage facilities. The preferred embodiment has the dynamic routing system utilize at least one parameter of the physical parameter set and point parameter set to establish statistical probability projected database for the location's specific probability of requirements, particularly preferred such that probability of requirements is a function of time. The specific probability of requirements determines the placement of service assets, power generation systems, environmental systems, and particularly of deployable cargos when the deployable cargo is an energy storage device as a further function of time for locations in proximity. Specifically, the predictive time required for redeployment of deployable cargos at near second locations from within a location candidate set, where the near second locations have energy demand profile and energy storage capacity that can be shifted to address backup energy capacity shortfall at the first location. The probability of requirements is based on historic records, predictive weather, energy demand profiles, available assets providing generally local redundancy, and most importantly the predicted time to transport deployable assets and deployable cargos to the current first location from a second location including docking receiving capacities at swapping with reconfiguration stations and/or intermediate staging stations within proximity of a location candidate set. It is understood that aforementioned references to energy storage devices and energy storage capacity is for bother electrical energy storage devices as well as thermal energy storage devices, and furthermore that available thermal energy storage capacity reduces the otherwise energy demand profile of electrical energy storage devices as well as power generation system.

The preferred embodiment takes into account at least one parameter from the point parameter set and/or physical parameter set both including the statistical probability projected database to establish available energy storage device and energy production failure and energy production device availability at a second location and the availability of deployable assets and swapping with reconfiguration stations as well to meet predicted energy demand profile at the current first location.

The particularly preferred embodiment has both the backup energy capacity shortfall and at least one parameter from the physical parameter set and/or point parameter set including their respective statistical probability projected databases.

The specifically preferred embodiment has both the energy production failure and at least one parameter from the physical parameter set and/or point parameter set including their respective statistical probability projected databases.

In all embodiments it is further preferred to include the prioritization response system having at least one parameter from the point parameter set and/or physical parameter set and its respective statistical probability projected database to establish routing by the dynamic routing system. Additional features including verification of delivery acceptance method, dynamic addressing, and pricing variations as determined by the dynamic pricing system are anticipated in the optimal embodiment of the inventive reconfigurable asset swapping system as realized by the reconfigurable asset system particularly at the swapping with reconfiguration stations.

### Inventory Control

As noted earlier, the inventive system includes a comprehensive inventory control database that is a critical part of the dynamic routing system for the reconfiguring of deployable assets and deployable cargos by reconfigurable asset swapping system for dynamically repositioning of the DCs, docking connector(s), trailer(s), vehicle(s), module(s) and/or even SR Station(s) as well as intermediate staging station(s). Virtually all assets further leverage a dynamic addressing system, including for assets that are traditionally stationary (i.e., having static address). The dynamic addressing system in the preferred embodiment also leverages a dynamic and variable geofence in which the dynamic addressing system determines a precise address in which the deployable assets and deployable cargos establish permanent or temporary movement by the deployable assets within parametric constraints on asset movements within the physical parameter set and the point parameter set that is location specific. The constraints are determined by asset ownership, boundary or border limitations, membership class limitations that are geographically based classes, or a geofence defined by asset transit limitations (e.g., a DC can be moved within a geofence superset but only by a vehicle constrained subset). The variable geofence as established by the dynamic addressing system further features a time-based schedule f(t) (as noted earlier, schedules are established as a function of at least one of fixed schedule database, feedback schedule database or feedforward schedule database) in which the geofence can switch between an active mode and inactive mode (e.g., a specific vehicle type being prohibited for entry, such as for noise, during evening hours or during all hours during a weekend) and more preferred where the mode is a function of class of DC, module, trailer, and/or vehicle.

An important feature of the feedforward control system is to identify asset cargo capacity constraints prior to the predicted shortfalls leading that would lead to failed timely deliveries as projected accounting for the statistical probability projected database. In addition to pre-positioning system assets to reduce or eliminate failed timely deliveries, the feedforward control system performs an asset-based sensitivity analysis based on additional asset units increasing the aggregate system capacity that includes asset cargo capacities, energy storage capacities, docking receiving capacities, and energy production capacities. Declining cost of assets, notably vehicle costs and energy storage device costs, and even on-site availability of low-cost fuels (e.g., hydrogen, biofuels, methane) relative to centralized utility in-front-of-meter energy costs provided into the feedforward control system leads to deployment of additional energy storage capacity closer to the ultimate user of energy including at the next location(s). This includes reconfiguring of DC energy storage, especially when SR Stations combined with across industry standardization, being repurposed from vehicles (even electric vehicles outside of the asset reconfiguration ecosystem in its first phase of use) to next SR stations or intermediate staging stations regular energy requirements and to ultimately next station infrequent emergency backup energy requirements as known in the art. The outright purchase price of energy storage device assets is declining at a steady and accelerating pace leading to a different ecosystem optimization equation encouraging the placement of larger capacity DC energy storage device assets at next locations.

The above occurrence of larger on-site deployable cargos having a preferred energy storage capacity at next location(s) in fact shifts the deployment of on-site power generation systems to become the embedded deployable cargo, to make up for any on-site on-demand shortfalls of any on-site renewable energy assets permanently (or even temporarily e.g., solar panels, wind turbines, etc.) at the next location. The preferred power generation system asset is a multi-fuel capable asset including electrochemical hydrogen generators or methane pyrolysis hydrogen fractionators specifically preferred using of on-site prepared organic molecules having a net electricity consumption rate lower than 15 kWh per kilogram of hydrogen (preferred lower than 10 kWh, particularly preferred lower than 8 kWh, and specifically preferred lower than 5 kWh) all enabling net electricity production even during on-site hydrogen production. The particularly preferred power generation system asset is both a multi-fuel capable asset having an external combustion component that enables the decoupling of fuel delivery (or standard on-site availability such as natural gas pipeline, on-site fermentation of on-site generated organic waste including filamentous fungi that produce hydrogen) enabling simpler positioning of docking position through docking connector by the docking mechanism to support transporting of deployable cargo assets to next location receiving docking port (i.e., both no combustible fluid transfer and no transport of combustible fluid within vehicle, trailer, module, or DC). Furthermore, the deployable cargo is smaller in size which also reduces its logistics costs for deployment from a first location to a second location.

The particularly preferred embodiment of the multi-fuel capable power generation system asset is a high-speed turbomachinery with external combustion. High-speed turbomachinery is particularly compact thus reducing the logistics costs associated with the dynamic and varying location of this asset. The external combustion not only inherently adds to the fuel flexibility but importantly enables the docking requirements to be limited to electricity transfer (and potentially added waste heat transfer) and not to combustible fuel transfer (i.e., fuel leak potential is greatly minimized). The latter being especially challenging in an automated manner for high-pressure hydrogen (or even moderate pressure natural gas). The fuel flexibility further enables asset commonality across a wider range of deployment locations therefore taking advantage of the wide range of fuel options that could vary seasonally, could vary due to transition to a decarbonized world, or could vary geographically such as biofuel, fossil fuel, etc. The particularly preferred high-speed turbomachinery operates a regenerative thermodynamic cycle. Having the high-speed turbomachinery decoupled from the balance of system equipment (notably waste heat recovery and/or condenser, and optionally also regenerator) also has the benefit of decoupling the relatively higher maintenance item of the high-speed turbomachinery from the relatively lower maintenance item of the balance of the system therefore enabling the reconfigurable assets and logistics systems to enable off-site maintenance with simplicity. The high-speed turbomachinery as compared to the balance of system is the most expensive and most complex portion of the system, therefore like the earlier noted deployable cargo assets, in which high asset utilization is a system objective of the reconfigurable asset swapping system. A further, particularly preferred embodiment of the high-speed turbomachinery has an integral wireless power transmitted as known in the art (that would even further reduce precision docking requirements of the docking mechanism) where the wireless power transmitter establishes an MFA-MC with the wireless power receiver and therefore substantially reduces the power generation system functionality in the event of a non-authorized (including stolen) asset deployment. The further benefit of external combustion of the high-speed turbomachinery is the virtual elimination of any onboard fuel transport requirements within the DC, module, trailer, or SR Station. In other words, the virtually complete elimination of onboard fuel virtually (if not completely) eliminates the transport logistics of any flammable fluids. High-speed turbomachinery, as known in the art, features either magnetic or airfoil bearings to further eliminate the presence of oil/lubricants (both of which are flammable). The preferred multi-fuel, external combustion empowered high-speed turbomachinery has less than 30 percent of residual fuel (specifically preferred less than 10 percent of residual fuel, and particularly preferred less than 2 percent of residual fuel, and absolutely preferred less than 0.1 percent of residual fuel) within the transportable power generation system components as compared to a non-external combustion empowered high-speed turbomachinery. The utilization of stationary (at least relative to the mobile repositioning of the high-speed turbomachinery) fuel storage tanks or available on-site fuel distribution capabilities (e.g., natural gas pipeline) further reduces the weight and volume of mobile components versus stationary components, recognizing the storage of liquid fuels is very inexpensive as compared to any other form of energy storage. In other words, only the most capital-intensive components are transported to locations amongst the location candidate set. The net result is a much lower physical size (and weight) of high-speed turbomachinery, the elimination of residual fuels within the high-speed turbomachinery through the decoupled external combustion component, and the further decoupling of fuel storage from the power generation system further enables the utilization of the higher energy efficiency use of biofuels (having an intrinsically higher oxygen content as compared to fossil fuels, therefore reducing the compression energy requirements for the high-speed turbomachinery thermodynamic cycle).

It is known in the art of on-site power generation system to leverage combined power and heat (i.e., waste heat) at the host site location, and reconfiguring the deployable cargo assets can easily utilize an on-site stationary pump to feed into the deployable cargo with a top loading, largely gravity fed, waste heat thermal transfer fluid (e.g., water, thus having no environmental concerns due to any accidental leakage) feeding back into a second receiving docking port via docking connectors for return of the now heated thermal transfer fluid. A specifically preferred deployable cargo is a thermo-acoustic heat pump to provide on-site air conditioning and/or refrigeration, that also benefits from the ever-declining cost of solar thermal systems to reduce the logistics requirements associated with stored thermal energy. The hybrid combination of permanently (or at least permanently on a variation of time of day or seasonal or event driven basis) positioned DC as a feature of the reconfigurable asset swapping system such that the feedforward control system includes on-site variations into stored energy storage device deployable cargo at the next location to determine statistically probable requirements as a function of the statistical probability projected database for additional deployable cargo requirements with scheduling task delivery and reconfiguration via the SR Station(s). It is understood that the SR Station(s) can also have a hybrid combination of permanently (or at least permanently on a seasonal or event driven basis) positioned deployable cargo as a feature of the reconfigurable asset swapping system such that the feedforward control system includes on-site charging variations of energy storage device deployable cargo to serve on-site internal SR Station energy requirements, SR Station deployable stored energy density change deployable cargo to meet next location(s) energy requirements, and SR Station deployable energy storage device DCs to meet vehicle in-transit energy requirements.

The feedforward control system for the reconfigurable asset swapping system is fundamentally comprised of two integrated feedforward control systems each with feedforward outputs, the aforementioned first feedforward control system for logistics delivery of deployable assets and the second feedforward control system for on-site next SR station energy requirement predictions collectively creating energy storage device requirements for both electrical and thermal (both hot and cold, potentially additional temperature segments within each of the hot and cold storage requirements) stored energy types. The inventive hybrid solution has the next location consumers of thermal energy storage device in thermal communications first with a first on-site thermal energy storage device asset (that is non-deployable), with the first on-site thermal energy storage device asset in thermal communications with a second deployable thermal energy storage device DC (that is deployable). An optional configuration is a first thermal environmental system (i.e., heater, cooler, heat pump, etc.) that is in thermal communications with the first on-site thermal energy storage device such that the thermal communications is on a branched circuit that doesn't interfere with a series circuit between the first on-site thermal energy storage device and the second deployable thermal energy storage device deployable cargo. A further optional configuration is a second thermal environmental system that is in thermal communications with the first thermal energy storage device asset (on-site at next location) and in parallel with a second thermal energy storage device asset (deployable DC). The preferred embodiment is the first thermal environmental system (on-site at next location) of at least 10 percent smaller (preferably at least 25 percent smaller, particularly preferred at least 50 percent smaller, and specifically preferred at least 80 percent smaller) than a second thermal environmental system (deployable to next location) such that the first thermal environmental system (or other thermally activated system) operates preferentially from on-site renewable energy assets; and the first thermal energy storage device asset (on-site at next location) capacity is at least 10 percent larger (preferably at least 25 percent larger, particularly preferred at least 50 percent larger, and specifically preferred at least 80 percent larger) than the second thermal energy storage device (deployable DC to next location). This novel reconfiguring minimizes the logistics requirements in terms of movement of stored energy through the utilization of the least expensive form of stored energy being thermal energy storage.

### Multi-Functional Structures for Stackable Systems

A deployable cargos (or trailer or module) docking ports on the top position of the deployable asset is ideal in terms of ensuring access without requiring docking connector mating management otherwise when a DC is in very close proximity to a vertical wall (i.e., exterior wall) of the next SR station or next location, yet creates high weather susceptibility therefore requiring a weather barrier that covers the DC's top mounted docking port(s). The weather barrier is best realized, as noted earlier, by a weather barrier that is preferably in continuous structural communication with a vertical structure (preferably a wall) of the next location. The weather barrier in this case serves at least one additional function selected from the group of security locking of deployable cargo to the weather barrier (and thus having physical communications with the location). The preferred weather barrier also serves as an integral guide rail for the docking mechanism to effectively reduce at least one axis degree of freedom motion control for the required actuator(s) to achieve successful docking with the receiving docking port(s) of the next location. The particularly preferred weather barrier is foldable such that in its extended horizontal deployed position it can cover multiple (and variable amounts of) DCs. The specifically preferred weather barrier is in its vertical orientation so as to not interfere with the vehicle placement of the trailer, or module, or DC at the next location; followed by subsequent movement to a horizontal orientation to achieve guide rail functionality of the docking port and/or docking connectors actuators, weather barrier to the DC(s), structural communication and placement of the receiving docking port(s) (which minimizes the amount of exposed power cables (e.g., copper or aluminum) to reduce opportunity for stealing of valuable metals particularly when the deployable cargo is a power generation system having power cables that are not currently being utilized, and also providing physical structural communication to the DCs also reducing the opportunity for stealing the contents of the DCs (or trailer or module). The weather barrier can be foldable or rollable (including slat roller) from its vertical non-extended placement (or rolled-in position) to its horizontal extended placement (or rolled-out position).

Deployable Assets and/or Asset Resulting Products

The inventive system that drives down logistics costs creates new opportunities for shared resources at many levels when combined with component interchangeability especially for higher-value components that are otherwise dedicated stationary assets (or “permanently” affixed to a specific vehicle). Standardization or design for interchangeability is critical to realize the maximum reconfiguring value of the reconfigurable asset system. Electrification of everything as a fundamental objective expands inherent interchangeability opportunities, particularly for mobility users (i.e., vehicles) by the elimination or reduction of traditional and highly vehicle-specific mechanical linkages, especially for traditional internal combustion engine powered vehicles. In addition to deployable motors (especially electric), the following category of deployable motors enables inherent utilization of low-cost piping between an electrically powered motor and the ultimate “power” transmission capability at multiple components leveraging such fluid (or air) movement for the transfer of power to the required receiving docking connector. In this manner, a receiving docking port for the otherwise low-utilization high-value deployable motor can be swapped across both mobility users and stationary users (i.e., decoupling of expensive components to achieve higher utilization factor). The fundamental goal is to reduce the aggregate cost of the low utilization device such that the actual motor driving the actuator achieves higher utilization through repositioning of the deployable motor to a location amongst the location candidate set by the dynamic routing system.

Preferred deployable motors are actuated by a magneto hydraulic, pneumatic, or hydraulic actuator. As noted earlier, other functionality or class of service assets can be interchanged such as deployable seating or virtually any product that is transportable by a deployable cargo on a deployable asset. The reconfiguring of a deployable asset's seating using a deployable seating differentiating between passenger, client, or employee seating; or additionally simply removing the deployable seating to enable standing within the vehicle interior of the deployable asset provides both additional asset cargo capacity and often simpler loading or unloading of deployable cargo.

Deployable systems include a) environmental systems such as heat pump or other thermal systems include air conditioning, refrigeration, dehumidifiers, boilers, etc., b) power generation systems, c) vacuum, and/or d) shared resources for scheduled times in which higher demands are anticipated. It is understood that placement of such swappable (i.e., deployable) systems at a next location then establishes temporarily the next location becoming a mini-functional SR Station due to placement of the respective asset when general ecosystem usage is enabled (as opposed to dedicated on-site private usage when deployed at a next location). It is further understood that placement of deployable assets and deployable cargos at the next location typically still results in imperfect capacity matching, therefore the additional asset cargo capacity can be utilized to meet the future requirements at a subsequent next location (second) after fulfilling the current on-site location (first) requirements.

In addition, the feedforward control system dynamically changes any parameter of the point parameter set and/or physical parameter set for a specific DC including the routing to a location amongst the location candidate set by the dynamic routing system. As such the wireless communications portion of the feedforward control system communicates to a swapping with reconfiguration station or intermediate staging station a new sequence order and queueing lane for a projected deployable asset capable of transporting at least one deployable cargo and in most instances alters the last-mile routing vector for the vehicle upon arrival at SR station or intermediate staging station or location having multiple docking ports to a specific docking port. The feedforward control system utilizes all communicated parametric updates including service asset availability as a f(t).

Parametric updates further include communication of energy storage device energy storage capacity to a first location capable of charging the energy storage device and to a second location also having charging capability and energy storage capacity or energy production capacity based on predicted estimated arrival times with predicted residence time; receive from vehicle predicted depth of discharge level upon estimated arrival time at next location and second next location (assumes no intermittent charging at next location). The controller communicates to each docking port for each DC the next charging rate threshold, the ending charge level prior to leaving docking port, the projected leaving time from docking port; and rate as a function of aggregate charging level at next station and second next station including based on charge consumption for travel between next station and second next station. It is understood that each of these parameters are included in the physical parameter set and/or location-specific point parameter set.

The particularly preferred dynamic routing system includes the additional parameters on a location-specific basis and thus included in the f(t, point parameter set, location within location candidate set). These include: a) docking direction as a function of queuing position of deployable cargo, b) docking position at docking port, c) earliest allowed estimated arrival time, d) latest allowed estimated arrival time, e) projected unloading of deployable cargo as a function of queueing position of deployable cargo, f) predicted depth of discharge of both swappable vehicle energy storage device and non-swappable vehicle energy storage device, and g) projected estimated arrival time preferably updated in real-time.

The feedforward control system is also a function of time and energy demand profile (both peak power and aggregate energy) as f (variations of time of day or seasonal) Routing by deployable asset having acceptable pre-positioning by the pre-positioning system for the docking port(s) of scheduled future receiving dock docking positions. The swapping with reconfiguration station is reconfiguring at least an orientation change of the energy storage devices, docking connector type, and pre-positioning system equipment to enable deployable cargo at addresses determined by the dynamic addressing system including the staging of deployable assets to achieve asset cargo capacity that exceeds any f(t) of energy storage capacity with energy production capacity.

The deployable system fundamentally addresses the aggressive price reductions of energy storage devices currently taking place leading to a transition from energy storage devices (particularly for non-inventive electric vehicles such that the driver won't experience range anxiety) being one of the most expensive components to vehicle guidance and control systems for electric autonomous vehicles becoming one of the most expensive components. To that end, it is anticipated that the reconfigurable asset swapping system at either swapping with reconfiguration stations or intermediate staging stations will utilize the feedforward control system to first decouple the guidance and control system of the autonomous vehicle mobility user from at least a portion of on-board energy storage devices. This system objective is one primary motivation for deployable cargos to be transported by deployable assets having a guidance and control system to perform routing as determined by the dynamic routing system such that the deployable asset actually uses a trailer as the carrying means for the deployable cargo.

The reconfigurable asset system within the swapping with reconfiguration station has at least one parameter value of the first physical parameter set with a difference of at least 2 percent from at least one parameter value of the second physical parameter set. It is further understood that a first docking connector for the at least one deployable cargo to connect at the first location is one component (and therefore having at least one different parameter from within the physical parameter set) being different from the docking connector required at the second docking port for at least one deployable cargo to connect when at the second location. A pre-positioning system is utilized to account for variations of at least 2 percent between a first docking position at a first location and a second docking position at a second location. A further capability includes reconfiguring the deployable cargo from the first deployable cargo physical parameter set to the second deployable cargo physical parameter set. The deployable cargo at a first location with a first location energy demand profile is predicted by the statistical probability projected database (as well as for all other locations including the second location). The statistical probability projected database predicts a backup energy capacity shortfall of a second location aggregate of the deployable cargo energy storage capacity and the deployable cargo energy production capacity and optionally accounts for a second energy production failure. The resulting dynamic routing system schedules at least ten percent of the excess of the first location aggregate of the deployable cargo energy storage capacity and the deployable cargo energy production capacity and optionally accounts for the first energy production failure to be moved from the first location to the second location by the deployable asset with optional reconfiguring at the swapping with reconfiguration station.

The combination of feedforward control system, fixed schedule database, and feedback schedule database optimize the utilization of energy storage devices by reconfiguring at least one deployable cargo from a first deployable cargo physical parameter set to a second deployable cargo physical parameter set. Varying the energy storage capacity by at least 10 percent (preferably greater than 20 percent, particularly preferred greater than 50 percent, or reducing by at least 10 percent (preferably greater than 20 percent, particularly preferred greater than 50 percent) as compared to the second energy storage capacity optimizes energy storage device utilization factor despite variations of time of day or seasonal. Reconfiguring also leverages the dynamic pricing system to establish a first estimated price for the first power generation system such that the statistical probability projected database provides for the first energy storage device a first estimated arrival time of the first energy storage device at the first swapping with reconfiguration station location, and the statistical probability projected database also provides for the first energy storage device a second estimated arrival time of the first energy storage device at the second swapping with reconfiguration station location. Further consideration accounts for the first estimated price at the first estimated arrival time such that the deployable asset transports the first energy storage device to the lower by at least 2 percent of the first estimated price at the first estimated arrival time to the first swapping with reconfiguration station or the second estimated price at the second estimated arrival time at the second swapping with reconfiguration station.

Another inventive feature has the first location utilizing a first stationary energy storage device (i.e., stationary mode), the second location being mobile (i.e., a vehicle), and the deployable asset consuming energy from the second energy storage device while the deployable asset moves between a swapping with reconfiguration station to a second location.

Yet another inventive feature has the first estimated price including the summation of a charging price for the first energy storage device and a transporting price for the first energy storage device from the first location to the first swapping with reconfiguration station and from the first swapping with reconfiguration station to the second location. The second estimated price includes the summation of a charging price for the first energy storage device and the transporting price for the first energy storage device from the first location to the second swapping with reconfiguration station and from the second swapping with reconfiguration station to the second location.

One preferred embodiment of the reconfigurable asset swapping systems is a deployable cargo being a portable data center. The dynamic routing system and dynamic addressing, utilized to determine the location, uses the feedforward control system to determine where and when waste heat from the operable data center can be utilized whether that location is a first location, a second location, a swapping with reconfiguration station or an intermediate staging station, further understanding that this accounts for variations of time of day or seasonal. As known in the art, data centers have empty zones to allow for proper cooling by airflow, and therefore the inventive feature of the reconfiguring reconfigurable asset swapping system includes collapsible reconfiguring (reducing equipment footprint by at least 5 percent, preferably at least 20 percent, and particularly preferred at least 50 percent) to occupy less physical space including at least partial removal of existing inventory (specialized servers as deployable cargo) to further ensure over the road restrictions, and also availability of deployable assets to move existing deployable cargo are all met.

To this end, particularly preferred deployable cargo includes other collapsible equipment such as washing machines and other appliances, clothing folding machines, furniture, and 3d printing/additive manufacturing equipment. Another embodiment has the deployable cargo being plant propagation equipment, or seedlings being distributed resulting from prior operation of the plant propagation equipment within the context of forward logistics task or reverse logistics task due to the lightweight nature of the seedlings especially relative to energy storage devices.

Another anticipated, yet specialized use case, is an autonomous vehicle for electric vehicle charging or battery swapping such that the onboard computing power (especially as required for guidance and control system within autonomous operations) not being utilized (i.e., autonomous vehicle is stationary), or underutilized while traveling due to less demanding driving conditions becomes an edge computing device within a data center (including dynamic addressing data centers). The particularly preferred embodiment utilizes the dynamic routing system such that both predictive computational spare capacity and charging capacity are accounted for.

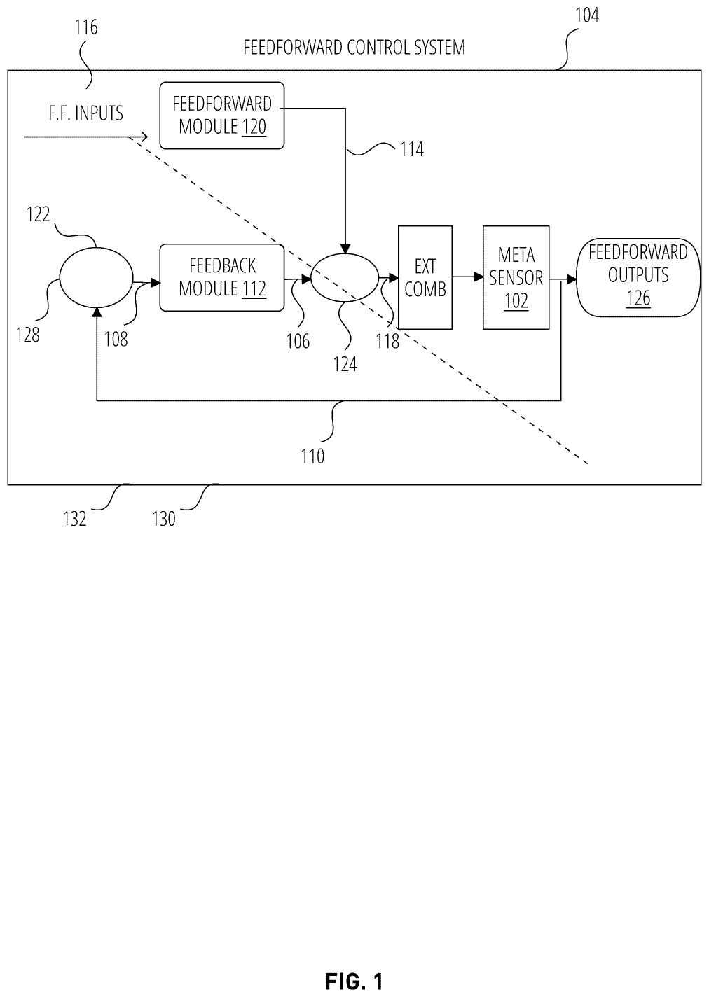

Turning to FIG. 1 depicts the feedforward and feedback loop control system 130 which is the preferred embodiment of control system 402 for monitoring all inputs and controlling all regulated outputs including the feedforward outputs 126.

The feedforward control system 104 regulates the at least one dynamic routing system 2-106 (not shown in this figure) as a function of either the stationary mode 260 (not shown in this figure) or the transportation mode 266 (not shown in this figure).

The feedforward control system 104 also regulates scheduling of autonomous vehicle 202, deployable cargo 208, and tasks including service tasks 256, forward logistics tasks 328, and reverse logistics tasks 252 (not shown in this figure).

In a number of embodiments, the reconfigurable asset swapping system 132 preferably uses a control system 402 as depicted in FIG. 1, that being a feedforward and feedback loop control system 130. The operations of the control system 402 may be carried out by the feedback module 112 at the minimum and preferably with the feedforward module 120 or may be embodied in different hardware. The control system 402 is configured to control the setpoints 128 corresponding to the parameters within the point parameter sets 232 and/or physical parameter sets 234 at the respective locations 224, and for the respective deployable cargos 208, autonomous vehicles 202, and reconfigurable asset swapping systems 132 for each swapping with reconfiguration station 230 at a minimum. The real-time meta sensor 102 (or any sensor value corresponding to a parameter of the point parameter set 232 or physical parameter set 234) of the reconfigurable asset system 246 or a reconfigurable asset swapping system 132. A feedback module 112 is configured to issue a feedback command 106 when the setpoint 128 sensor, as communicated through the feedback loop 110, moves from a setpoint 128 to produce a feedback error 108 (setpoint 128—any sensor value corresponding to a parameter of the point parameter set 232 or physical parameter set 234). Accordingly, the feedback module 112 only begins to respond after the any sensor value corresponding to a parameter of the point parameter set 232 has deviated from the setpoint 128 by the feedback error 108.

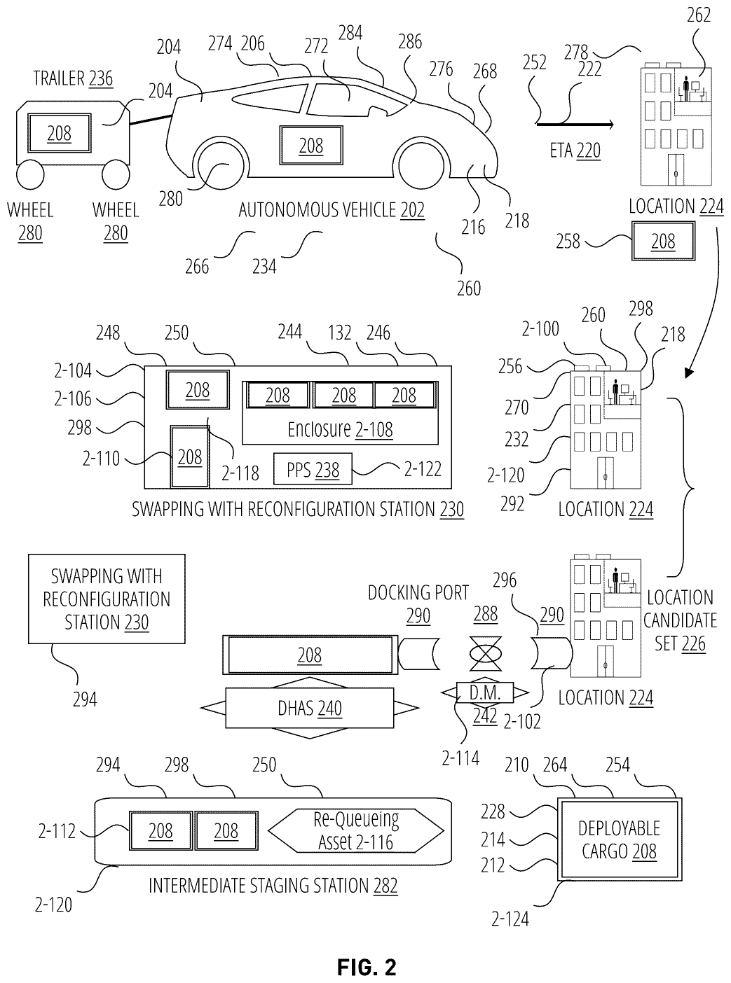

A feedforward module 120 is included to monitor any sensor value corresponding to a parameter of the point parameter set 232 by establishing a meta sensor 210 in the reconfigurable asset swapping system 132, which is used to predict an impact on a wide range of point parameter set 232 and physical parameter set 234 with particular monitoring of any sensor value corresponding to a parameter of the point parameter set 232 at the swapping with reconfiguration stations 230 and intermediate staging stations 282, before at least one of the real-time parameters of any of the point parameter sets 232 and physical parameter sets 234 is able to determine a resulting deviation from successful task completion for any of the deployable assets 206 and deployable cargos 208. The feedforward module 120 receives feedforward inputs 116, such as from any sensor (or meta sensor 102) value corresponding to a parameter of the point parameter set 232 and physical parameter set 234. The feedforward module 120 computes routing and scheduling for deployment of deployable assets 206 and deployable cargos 208 including their respective tasks by the dynamic routing system 2-106 (and though not shown preferentially accounting for additional system components as shown in FIG. 2. Based on the computed generated meta sensor 102, the feedforward module 120 issues a feedforward command 114 that alone or in addition to the feedback command 106 from the feedback module 112 determines a commanded feedforward modified command 118 to the reconfigurable asset swapping system 132 and achieve successful and on-time completion of tasks executed at the proper locations 224.

The feedforward and feedback loop control system 130 uses both the feedback comparator 122 and the feedforward comparator 124 respectively for the feedback loop 110 and feedforward control system 104.

Turning to FIG. 2 depicts a swapping with reconfiguration station 230 as well as intermediate staging station 282, in which the intermediate staging station 282 predominantly is for resequencing 250 of deployable cargos 208 as being transported by deployable assets (a.k.a. vehicle or preferably autonomous vehicle 202) to a next location 224. It is understood that the autonomous vehicle 202 can optionally have a trailer 236 (depicted as an additional deployable asset that is transported in tandem with the autonomous vehicle) transporting deployable cargos 208 (as depicted both within the trailer 236 and within the autonomous vehicle 202), such that deployable cargos 208 can be either only in the trailer 236 or in both the trailer 236 and autonomous vehicle 202). The autonomous vehicle 202 deploys the deployable cargo 208 as a forward logistics task 328 (not depicted in this figure) (and/or additionally retrieves deployable cargo 208 at the location 224 as a reverse logistics task 252 assigned along the same estimated arrival time 220 travel routing pathway (as determined by the dynamic routing system 2-106 accounting for the swapping with reconfiguration stations 230). The swapping with reconfiguration station 230 has the capability of both forward logistics tasks 328 and reverse logistics tasks 252 including the inventive reconfiguring 248 of deployable cargos 208, whether it be repackaging subcomponents of deployable cargo 208 into an enclosure 2-108 or repackaging subcomponents after orientation change 2-118 from a vertically oriented module 2-110 to horizontally oriented module 2-112 (and vice versa). The inventive utilization of intermediate staging stations 282 utilizing the re-queueing asset 2-116 provides the ability to change sequencing order as determined by the dynamic routing system 2-106 of deployable cargos 208.

The trailer 236 as depicted has a minimum of at least two wheels 280 and with both a real-time and function of time 326 asset cargo capacity 204 (as depicted for trailer 236 and autonomous vehicle 202). In particular the f(time 326, asset cargo capacity 204) is for all trailers 236, deployable assets 206, autonomous vehicles 202 on an individual basis. The docking receiving capacity 292 is analogous with the asset cargo capacity 204 for the swapping with reconfiguration stations 230, intermediate staging stations 282, and locations 224 again on an individual basis as a function of time 326.

The autonomous vehicle 202, as depicted also has at least two wheels 280, has a vehicle interior 272 (as noted throughout is also a deployable asset 206 and is considered a mobility user 284, and is preferably autonomous 286 with as known in the art components enabling driverless travel). The autonomous vehicle 202 utilizes its vehicle movement control system 274 to travel along a travel pathway as determined by the dynamic routing system 2-106 with a transporting price 268 as preferably determined by the dynamic pricing system 2-104. The autonomous vehicle 202 has an energy demand profile 218 and an emissions profile 216 attributed to energy consumption during transport. Importantly, the autonomous vehicle 202 utilizes two distinct mode determinations: transportation mode 266 (during travel) and stationary mode 260 (while stationary) where at least one parameter from the physical parameter set 234 is a function of (time 326, and mode). The estimated price 222 during travel includes the transporting price 268 incurred by the deployable asset 206. The travel pathway is a function of traditional forward logistics tasks 328 and importantly reverse logistics tasks 252, as the swapping with reconfiguration stations 230 and intermediate staging stations 282 inherently enable autonomous 286 resequencing 250 by re-queueing assets 2-116.

The locations 224 while executing their inventive features are a stationary user 262 (though not shown, a location 224 can be physically moved from a first location 224 to a second location 224, in which instance though always considered a stationary user 262 it would transition from a transportation mode 266 to a stationary mode 260 preferably as a function of time 326 such that the reconfigurable asset system 246 accounts for a locations 224 availability. The locations 224 availability is inherently known by the reconfigurable asset swapping system 132 by the function of (time, docking receiving capacity 292, and each parameter within the point parameter set 232) for each location 224. A fundamental feature of the reconfigurable asset swapping system 132 is the transporting of a specialized class of deployable cargos 208 being shared resources 258. Each location 224 has an energy demand profile 218 (and preferably backup energy capacity shortfall 2-100 that is a function of time 326 including dynamic changes attributed to variation of time of day or seasonal 270. The preferred location 224 also has systems that enable chain of custody control 298 accounting for shipping and receiving of deployable cargos 208 for each change of location 224 (as well as at each swapping with reconfiguration station 230 and intermediate staging station 282). Each location 224 preferably has the ability to execute service tasks 256, particularly with deployable cargos 208 that are temporarily at the respective location 224 in accordance to an inventory control database 324 (not depicted in this figure) and scheduled databases (depicted in other figures).

Though not shown, in any figures, it is understood that multiple queueing lanes 2-120 preferably exist for each location 224 (as depicted in other figure), swapping with reconfiguration stations 230, and intermediate staging stations 282. Furthermore, it is understood that the vehicle travel direction side 276 in which the autonomous vehicle 202 docks at the docking position 2-102 determined by the dynamic routing system 2-106 doesn't have to be the same as the direction in which the autonomous vehicle 202 predominantly travels between a first location 224 and a second location 224 (where location 224 can also be the same as swapping with reconfiguration station 230 or intermediate staging station 282 for multiple reasons including their respective utilization of deployable cargos 208).

Each swapping with reconfiguration station 230 preferably has all features, though for brevity and clarity within the figures a second instance of swapping with reconfiguration station 230 only shows dynamic addressing 294. Similar to locations 224 (that operate only in stationary mode 260) swapping with reconfiguration stations 230 can preferably have the capability of being moved from a first location 224 to a second location 224 where the physical address varies in accordance to an optimized dynamic routing system 2-106 within the reconfigurable asset system 246. Both reconfiguring 248 and resequencing 250 of deployable assets 206 (as shown autonomous vehicle 202) and deployable cargos 208 takes place accounting for optimal prioritization as determined by the prioritization response system 244, achieves high asset utilization factors by both preferably feedforward and feedback loop control system 130 within the reconfigurable asset swapping system 132, reconfigurable asset system 246, dynamic pricing systems 2-104, and dynamic routing system 2-106.

The particularly preferred embodiment for the swapping with reconfiguration station 230 is a pre-positioning system 238 (operations are detailed in other figures) having at least one axis degree of freedom motion 2-122 (though specifically preferred at least one greater number of axis degrees of freedom motion 2-122 than the docking mechanism 242 (not shown in this figure) at a respective location 224. The set of locations 224 are contained within a location candidate set 226, preferably where each swapping with reconfiguration station 230 and intermediate staging station 282 has a distinct location candidate set 226 (which preferably varies in accordance to time 326 and specifically preferred varies in accordance to variations of time of day or seasonal 270 for each location 224).

The deployable cargos 208 within the inventive system cover a wide range of every day systems (though with the inventive features achieve a substantially higher utilization factor, and thus a superior return on investment). These include; environmental system 2-124 (e.g., air conditioning heating, refrigeration, etc., deployable seating 212 (e.g., seating that can be removed from any vehicle, as well as traditional seating that is rented for deployment at a second location 224), deployable system 214 (e.g., industrial process equipment particularly having significant swings as a function of time 326 of utilization factor including deployable motors 210, and thermally activated systems 264), power generation system 228 (e.g., internal combustion engines, fuel cells, or specialized energy storage devices 302, etc.), and service asset 254 (notably a shared resource 258 asset).

The pre-positioning system 238 “PPS” preferably has a dynamic height adjustment system 240, though it is also anticipated the dynamic height adjustment systems 240 can be deployed at any location 224 or intermediate staging station 282 without the full capabilities of the pre-positioning system 238. The PPS functions to reduce the axis degrees of freedom motion 2-122 required by the docking mechanism 242 contained either within the deployable asset 206, deployable cargo 208, or location 224, therefore having the more complex docking mechanisms 242 achieving higher utilization factors. The PPS aligns the docking port 290 having docking connector 288 for proper transfer of either deployable cargo 208 from deployable asset 206 to location 224 or more preferred such that the deployable cargo 208 achieves proper functionality at the current location 224 through the location 224 docking port 290 having a specific docking position 2-102 (as noted earlier, each queueing lane 2-120 though not shown will optimally be capable of supporting distinct docking positions 2-102 relative to the location 224). The particularly preferred PPS has an at least one actuator 2-114 to change the condition of a compliant mechanism 296, such that the compliant mechanism 296 reduces the cost of the PPS notably by reducing the cost of docking connector 288 alignment by an at least 5 percent reduction of alignment precision (and preferably at least 10 percent, more preferred at least 20 percent, and specifically preferred at least 50 percent).

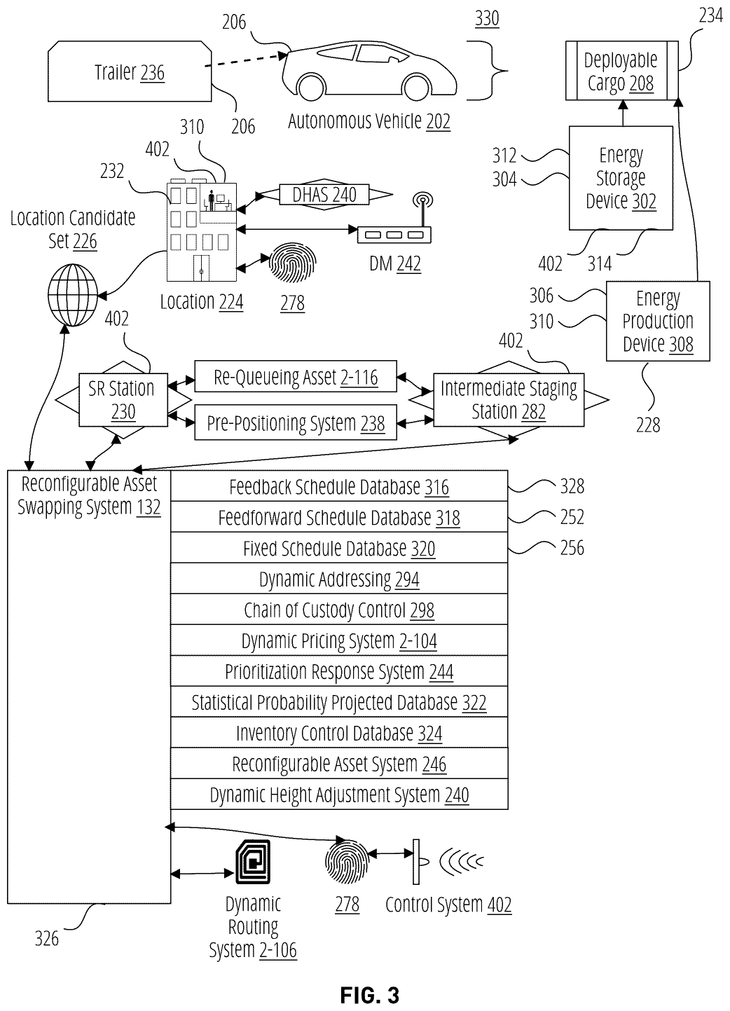

Turning to FIG. 3 again depicts the reconfigurable asset swapping system 132 in more detail, notably the various subsystems that further support the dynamic routing system 2-106 with the preferred verification of delivery acceptance method 278 for deployment of deployable cargo 208 from a first location 224 to a second location 224 including intermediate staging stations 282 and/or swapping with reconfiguration stations 230. As noted in FIG. 2, both the swapping with reconfiguration station 230 and intermediate staging station 282 preferably have each of re-queuing asset 2-116 and pre-positioning system 238 in addition to control systems 402 particularly for the inventive at least one of reconfiguring 248 and resequencing 250 of deployable cargo 208 between locations 224 from within at least one location candidate set 226 (preferably as noted before an individual location candidate set 226 for each intermediate staging station 282 and swapping with reconfiguration station 230.

The preferred swapping with reconfiguration station 230 has a reconfigurable asset swapping system 132 comprised of an aggregate scheduling system further particularly preferably comprised of feedback schedule database 316, feedforward schedule database 318, and fixed schedule database 320. Each of the aforementioned scheduling databases has forward logistics tasks 328, reverse logistics tasks 252, and/or service tasks 256 (though for brevity each of these is depicted as being within only of the schedule databases). The aggregate scheduling database specifically preferred utilizes the feedforward schedule database 318 in combination with the feedforward and feedback loop control system 130 to determine the optimal travel pathway (i.e., route) for each deployable cargo 208 and each deployable asset 206. The verification of delivery acceptance method 278 is critical to ensuring authenticated and certified delivery of every deployable cargo 208, a more than necessary feature for the inventive highly decentralized distribution system in which interactions take place in otherwise non-secure locations 224. Control systems 402 are utilized extensively throughout the system, both as known in the art as well as to explicitly support inventive features. The inclusion of at least one (and specifically preferred all) components comprised of dynamic addressing 294, chain of custody control 298, dynamic pricing system 2-104, prioritization response system 244, inventory control database 324, reconfigurable asset system 246, and dynamic height adjustment system 240 each with specific functionality as explained throughout. Each of these major components further utilize statistical probability projected database 322 (specifically preferred within each component and not just the aggregate) to schedule reconfigurings 248 and resequencings 250 throughout the reconfigurable asset swapping system 132. The statistical probability projected databases 322 themselves are a function of time 326 and preferably also account for variations of time of day or seasonal 270.

Each of the deployable cargos 208, which are optionally also as a function of deployable assets 206 (in this figure shown as autonomous vehicle 202), have physical parameter sets 234 that in part enable the reconfigurable asset system 246 to determine dynamic routing system 2-106 for each deployable asset 206 (which optionally, as shown, has a trailer 236 in which deployable cargos 208 can be transported by) for deployment of each deployable cargo 208.

The dynamic pricing system 2-104 is a function of location candidate set 226 for each of the locations 224. The dynamic pricing system 2-104 also utilizes estimated price 222, charging price 314 and transporting price 268 for each combination of autonomous vehicles 202 and location candidate sets 226 each having multiple locations 224.

As depicted in other figures, the pre-positioning system 238 takes into account both the autonomous vehicle 202 with its profile height 330 for docking at the next location 224. Deployable assets 206 references as noted elsewhere are interchangeable with trailer 236 and vehicles particularly autonomous vehicles 202 in their ability to transport and deploy deployable cargos 208 to next locations 224. A particularly preferred deployable cargo 208 includes specifically preferred both energy storage device 302 and energy production device 308. The energy storage device 302 has an energy storage capacity 312, energy density change 304, control system 402, and charging price 314 (for the infusion of either electrical or thermal energy). The energy production device 308 (of which includes power generation system 228) has at least the parameters including energy production capacity 306 and energy production failure 310 within its physical parameter set 234.

As depicted in this FIG. 3, though here only in a summary level, each location 224 has a point parameter set 232 and a control system 402, with preferred additions of energy production failure 310 when deployable cargo 208 are either power generation systems 228 or energy storage devices 302. The specifically preferred embodiment also has the verification of delivery acceptance method 278, docking mechanism 242, and dynamic height adjustment system 240 themselves having their respective control systems 402.

The parameters within the physical parameter sets 234 and point parameter sets 232 have at least one parameter value of the first physical parameter set 234 that is different by at least 2 percent from an at least one parameter value of the second physical parameter set 234.

The inventory control database 324 (though not depicted further) includes an inventory of the docking connectors 288 and the inventory of the docking ports 290 preferably as a function of time 326 (including time 326 as a further inclusion of variations of time of day or seasonal 270) and locations 224. Though not depicted in this FIG. 3, each of the docking connectors 288 and the docking ports 290 have physical parameter sets 234, which optionally are a function of locations 224, geofences 602.

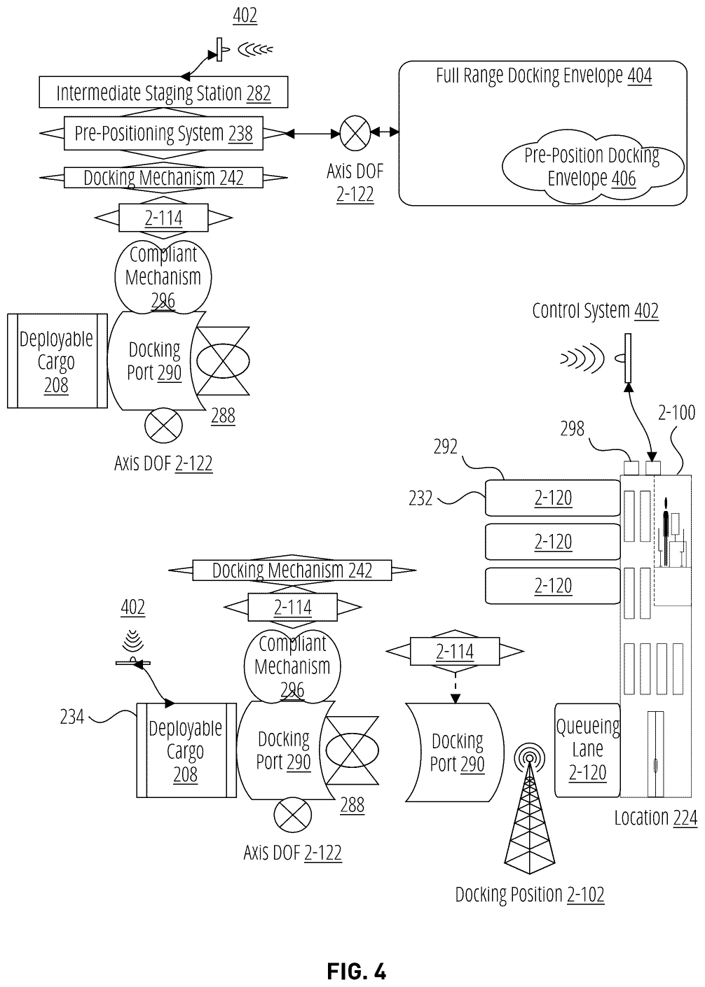

Turning to FIG. 4 illustrates a more detailed embodiment of the pre-positioning system 238 and its interactions throughout the reconfigurable asset swapping system 132 (not depicted as a whole). The top portion of this figure is intermediate staging station 282 centric (as shown, though understood to be equally relevant to swapping with reconfiguration station 230) having control systems 402 (as known in the art to have both wired and wireless communications) for continuous, intermittent, and periodic communications amongst the full set of deployable cargos 208 and deployable assets 206 in addition to the full set of locations 224 (inclusive of intermediate staging stations 282 and swapping with reconfiguration stations 230). The intermediate staging station 282 is in physical communication with the pre-positioning system 238 that is in turn in physical communications with the docking mechanism 242, that is then in turn in physical communication with an at least one actuator 2-114. The specifically preferred embodiment has the docking mechanism 242 comprised of at least one compliant mechanism 296, which is then in physical communications with the docking port 290 of the deployable cargo 208. The intermediate staging station 282 preferably has at least one additional axis degree of freedom motion 2-122 (as compared to a locations 224 docking port 290. It is understood that a first actuator 2-114 can have its physical communications with the docking port 290 at either of the intermediate staging station 282 or swapping with reconfiguration station 230 such that another second actuator 2-114 that remains at a location 224 enables the successful docking between the deployable cargo 208 and the location 224 docking port. The deployable cargo 208 is deployed with its own docking port 290 and docking connector 288 (which is preferably capable of being swapped at the swapping with reconfiguration station 230) for compatibility with the next location 224 docking port 290. As noted in a previous figure, the number of axis degrees of freedom motion 2-122 is higher at the pre-positioning system 238 (than the axis degree of freedom motion 2-122 on the deployable cargo 208) such that the PPS pre-positioning system 238 moves the deployable cargo 208 docking port 290 from within the full range docking envelope 404 to the subset of the pre-position docking envelope 406.

FIG. 4 further illustrates the location 224 centric perspective in more detail than other figures. Notably the location 224, again with its control system 402, chain of custody control 298, backup energy capacity shortfall 2-100, has as depicted multiple queueing lanes 2-120 (of which only the lower one depicts the additional components). Each queueing lane 2-120 has a precise docking position 2-102 at which its docking port 290 (having an optional actuator 2-114) is positioned for physical communications with the next deployable cargos 208. As noted in the top portion of this figure and in other figures, the deployable cargo 208 has its own docking port 290 (within the same configuration as in the top portion as the bottom portion).

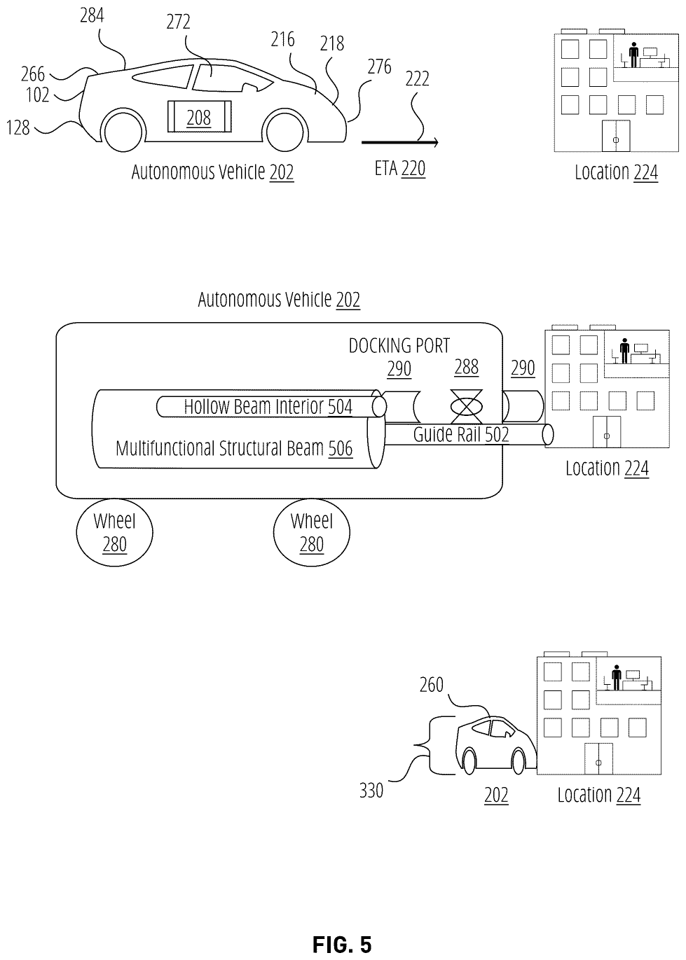

Turning to FIG. 5 illustrates more details for the deployable asset 206 (as autonomous vehicle 202 having at least two wheels 280). As noted in other figures, the autonomous vehicle 202 has an at least one deployable cargo 208. The vehicle movement control system is further comprised of a meta sensor 102, a setpoint 128, an emissions profile 216, an energy demand profile 218, an estimated arrival time 220, an estimated price 222, a next location 224, a change of modes between at least the stationary mode 260 and transportation mode 266, a vehicle interior 272, a vehicle travel direction side 276, an at least two wheels 280, and a docking connector 288, a docking port 290, a profile height 330. The autonomous vehicle 202 is inherently a mobility user 284.

The particularly preferred autonomous vehicle 202 leverages an at least one guide rail 502 at the location 224 for alignment of the autonomous vehicle 202 docking port 290 with the location 224 docking port through the docking connector 288. The specifically preferred docking connector 288 has a hollow beam interior 504 with a multifunctional structural beam 506, such that both respective beams provide multifunctional structural integrity within the autonomous vehicle 202. The beams are solely structural integrity when the autonomous vehicle 202 is in transportation mode 266 and is predominantly deployable cargo 208 physical communications between the autonomous vehicle 202 deployable cargo 208 and the location 224.

The deployable cargo 208 is projected to arrive at the next location 224 at estimated arrival time 220 with an estimated price 222 for transport from the previous location 224 to this next location 224.

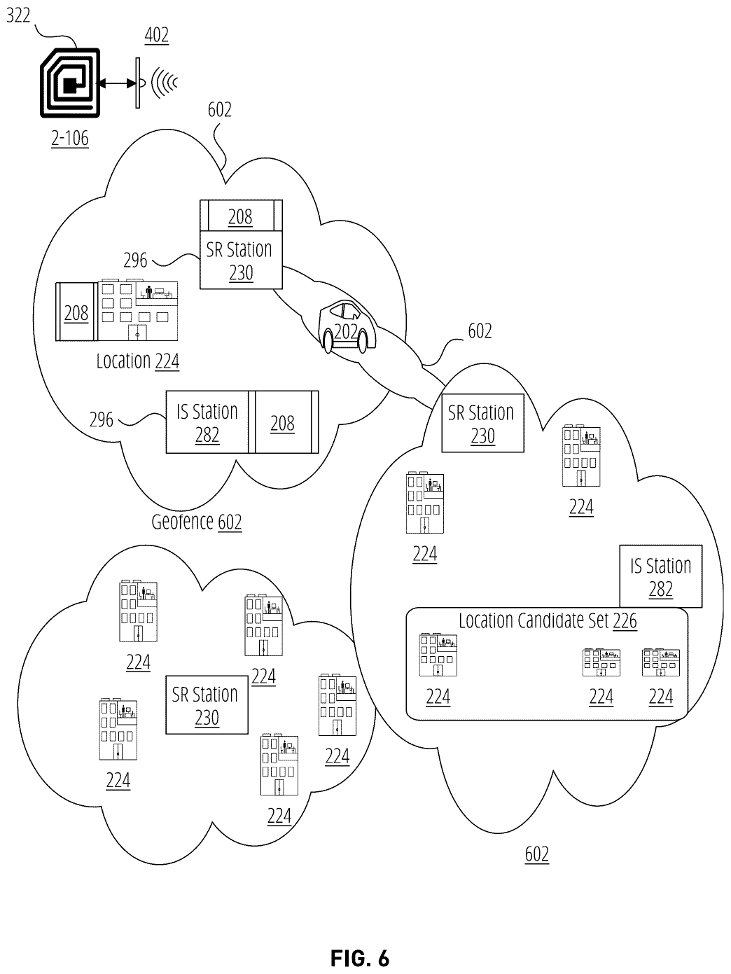

Turning to FIG. 6 illustrates additional details of the dynamic routing system 2-106 with its as known in the art control system 402 that includes the ability for bi-directional communications (also as known in the art) to all locations 224, deployable assets 206, and deployable cargos 208 (whether directly, or indirectly via deployable asset 206 transporting the respective deployable cargo 208. The dynamic routing system 2-106 preferentially has multiple geofences 602 each containing at least one location 224. The particularly preferred geofence 602 has at least one of swapping with reconfiguration station 230 or intermediate staging station 282. And the specifically preferred geofence 602 has at least one swapping with reconfiguration station 230 and at least one intermediate staging station 282. As noted in other figures, the preferred embodiment of the swapping with reconfiguration station 230 and intermediate staging station 282 has at least one compliant mechanism 296 within either its pre-positioning system 238 or docking mechanism 242. As noted earlier, the dynamic routing system 2-106 specifically prefers to be comprised of, and accounting for, the statistical probability projected database 322.

An optional second class of geofences 602 is solely a transport corridor in which the autonomous vehicle 202 (as shown) moves via any deployable asset 206 (as shown here as autonomous vehicle 202) between a first geofence 602 and a second geofence 602, where this class of geofences 602 is void of any location candidate sets 226 having their respective locations 224 (though never preferred).

While the invention has been described in connection with various embodiments, it will be understood that the invention is capable of further modifications. This application is intended to cover any variations, uses or adaptations of the invention following, in general, the principles of the invention, and including such departures from the present disclosure as, within the known and customary practice within the art to which the invention pertains.

What is claimed is:

1. A reconfigurable asset system comprised of a swapping with reconfiguration station, a deployable asset operable to transport an at least one deployable cargo having a deployable cargo docking port, a first location having a first docking port and a first deployable cargo physical parameter set, an at least one second location having a second docking port; whereby the first docking port has a first physical parameter set for the first docking port; whereby the second docking port has a second physical parameter set for the second docking port; whereby an at least one parameter value of the first physical parameter set is different by at least 2 percent from an at least one parameter value of the second physical parameter set; and whereby the deployable cargo docking port is changed from the first physical parameter set to the second physical parameter set at the swapping with reconfiguration station upon arriving from the first location and prior to departing to the second location.

2. The reconfigurable asset system of claim 1 wherein the first docking port requires a first docking connector for the at least one deployable cargo to connect at the first location; wherein the second docking port requires a second docking connector for the at least one deployable cargo to connect at the second location; whereby the first docking connector is different than the second docking connector; and whereby the swapping with reconfiguration station switches the first docking connector of the at least one deployable cargo to the second docking connector of the at least one deployable cargo.

3. The reconfigurable asset system of claim 1 whereby the deployable asset is further comprised of a deployable asset docking port; wherein the first docking port requires a first docking position to connect at the first location; wherein the second docking port requires a second docking position to connect at the second location; whereby the first docking position is different by at least 2 percent than the second docking position relative to the deployable asset docking port; and whereby the swapping with reconfiguration station has a pre-positioning system to switch a deployable asset docking position from the first docking position to the second docking position.

4. The reconfigurable asset system of claim 1 further comprised of a dynamic pricing system and a location candidate set having a group of candidate locations that includes the first location and the second location; whereby the deployable asset transports the at least one deployable cargo to the first location for a first time from a fixed schedule database; whereby the first location and the first time for the at least one deployable cargo is optimized using the dynamic pricing system; and wherein the first location with the first docking port is compatible with the deployable cargo docking port.

5. The reconfigurable asset system of claim 1 is further comprised of a dynamic routing system whereby the dynamic routing system chooses the deployable cargo from the first location having the first physical parameter set, chooses the second location and the second physical parameter set, and chooses the swapping with reconfiguration station in which the deployable cargo is reconfigured from the first physical parameter set to a second physical parameter set; and whereby the second physical parameter set deviates from the first physical parameter set due to an at least one variation of time of day or seasonal between the first location and the second location.

6. The reconfigurable asset system of claim 1 whereby the deployable cargo docking port has a deployable cargo full range docking envelope further comprised of a deployable cargo full range docking envelope at least one axis degree of freedom motion; whereby the first location docking port has a first location full range docking envelope further comprised of a first location docking port full range docking envelope at least one axis degree of freedom motion; whereby the first location docking port full range docking envelope at least one axis degree of freedom motion is a first subset of the deployable cargo full range docking envelope at least one axis degree of freedom motion; and whereby the deployable cargo docking port is prepositioned to within a pre-position docking envelope from the deployable cargo full range docking envelope at least one axis degree of freedom motion to the first location docking port full range docking envelope at least one axis degree of freedom motion.

7. The reconfigurable asset system of claim 6 whereby the second location docking port has a second location full range docking envelope with a second location docking port full range docking envelope at least one axis degree of freedom motion; and whereby the deployable cargo docking port prepositioned to within the pre-position docking envelope from the deployable cargo full range docking envelope at least one axis degree of freedom motion to both the first subset of the deployable cargo full range docking envelope at least one axis degree of freedom motion and a second subset of the deployable cargo full range docking envelope at least one axis degree of freedom motion.

8. The reconfigurable asset system of claim 1 is further comprised of a dynamic routing system; whereby the dynamic routing system chooses the deployable cargo from the first location having a first deployable cargo physical parameter set, chooses the second location having a second deployable cargo physical parameter set, and chooses the swapping with reconfiguration station in which the deployable cargo is reconfigured from the first deployable cargo physical parameter set to the second deployable cargo physical parameter set; whereby the deployable cargo is either a deployable cargo energy storage device or deployable cargo energy production device having a deployable cargo energy storage capacity or a deployable cargo energy production capacity; whereby the first location has a first location energy demand profile predicted by a statistical probability projected database; whereby the second location has a second location energy demand profile predicted by the statistical probability projected database; whereby the statistical probability projected database predicts an excess of a first location aggregate of the deployable cargo energy storage capacity and the deployable cargo energy production capacity and optionally accounts for a first energy production failure; whereby the statistical probability projected database predicts a backup energy capacity shortfall of a second location aggregate of the deployable cargo energy storage capacity and the deployable cargo energy production capacity and optionally accounts for a second energy production failure; and whereby at least ten percent of the excess of the first location aggregate of the deployable cargo energy storage capacity and the deployable cargo energy production capacity and optionally accounts for the first energy production failure is moved from the first location to the second location by the deployable asset with optional reconfiguring at the swapping with reconfiguration station.

9. The reconfigurable asset system of claim 1 wherein the swapping with reconfiguration station further comprising a dynamic routing system; whereby the swapping with reconfiguration station is operable as an intermediate staging station and having an optional reconfigurable asset system operable to vary the configuration of the deployable cargo from the first deployable cargo physical parameter set to the second deployable cargo physical parameter set; whereby the intermediate staging station has a dynamic addressing location; and whereby the dynamic addressing location is optimized by the reconfigurable asset system using the dynamic routing system for the transporting of the deployable cargo by the deployable asset from the first location to the swapping with reconfiguration station and from the swapping with reconfiguration station to the second location.

10. The reconfigurable asset system of claim 1 is further comprised of a dynamic routing system and a feedforward control system to establish a feedforward schedule database of the at least one deployable cargo from the first location to the swapping with reconfiguration station and then from the swapping with reconfiguration station to the second location as a function of any individual or combination of a prioritization response system, a feedback schedule database, an environmental system, or a dynamic pricing system.

11. A reconfigurable asset system comprised of an at least one swapping with reconfiguration station, a deployable asset operable to transport an at least one deployable cargo whereby the at least one deployable cargo is an energy storage device, a first location having a first docking port and a first energy storage capacity for the energy storage device, a second location having a second docking port and a second energy storage capacity for the energy storage device; whereby the at least one swapping with reconfiguration station varies the configuration of the at least one deployable cargo from a first deployable cargo physical parameter set to a second deployable cargo physical parameter set; and whereby the first energy storage capacity is different by at least 10 percent than the second energy storage capacity.

12. The reconfigurable asset system of claim 11 is further comprised of a dynamic routing system whereby the dynamic routing system chooses the at least one deployable cargo from the first location, chooses the second location, and chooses the swapping with reconfiguration station in which the at least one deployable cargo is reconfigured from the first deployable cargo physical parameter set to the second deployable cargo physical parameter set; and whereby the second deployable cargo physical parameter set deviates from the first deployable cargo physical parameter set due to an at least one variation of time of day or seasonal between the first location and the second location.

13. The reconfigurable asset system of claim 11 whereby the at least one swapping with reconfiguration station receives the first energy storage device from the first location; whereby the at least one swapping with reconfiguration station then reconfigures the first energy storage device by an at least one physical parameter set prior to dispatching the first energy storage device as now reconfigured becoming the second energy storage device; whereby the at least one swapping with reconfiguration station then utilizes the deployable asset to transport the second energy storage device to the second location; and whereby the at least one physical parameter set includes an orientation change, an energy density change, a docking connector change, or a deployable asset change in which the second energy storage device is transported from the at least one swapping with reconfiguration station to the second location.

14. The reconfigurable asset system of claim 11 is further comprising a statistical probability projected database; whereby the at least one swapping with reconfiguration station is further comprised of a power generation system; whereby the at least one swapping with reconfiguration station is comprised of a first swapping with reconfiguration station having a dynamic pricing system establishing a first estimated price for a first power generation system and having a first swapping with reconfiguration station location; whereby the at least one swapping with reconfiguration station is comprised of a second swapping with reconfiguration station having the dynamic pricing system establishing a second estimated price for a second power generation system and having a second swapping with reconfiguration station location; whereby the statistical probability projected database provides for the first energy storage device a first estimated arrival time of the first energy storage device at the first swapping with reconfiguration station location; whereby the statistical probability projected database provides for the first energy storage device a second estimated arrival time of the first energy storage device at the second swapping with reconfiguration station location; whereby the dynamic pricing system has the first estimated price at the first estimated arrival time; and whereby the deployable asset transports the first energy storage device to the lower by at least 2 percent of the first estimated price at the first estimated arrival time to the first swapping with reconfiguration station or the second estimated price at the second estimated arrival time at the second swapping with reconfiguration station.

15. The reconfigurable asset system of claim 11 whereby the first location utilizing the first energy storage device is stationary; whereby the second location is mobile; and whereby the deployable asset consumes energy from the second energy storage device while the deployable asset moves from the at least one swapping with reconfiguration station to the second location.

16. The reconfigurable asset system of claim 11 is further comprised of a dynamic routing system and a feedforward control system to establish a feedforward schedule database of the at least one deployable cargo from the first location to the at least one swapping with reconfiguration station and then from the at least one swapping with reconfiguration station to the second location as a function of any individual or combination of a prioritization response system, a feedback schedule database, an environmental system, or a dynamic pricing system.

17. The reconfigurable asset system of claim 14 whereby the first estimated price includes summation of a charging price for the first energy storage device and a transporting price for the first energy storage device from the first location to the first swapping with reconfiguration station and from the first swapping with reconfiguration station to the second location; and whereby the second estimated price includes summation of the charging price for the first energy storage device and the transporting price for the first energy storage device from the first location to the second swapping with reconfiguration station and from the second swapping with reconfiguration station to the second location.

18. A reconfigurable asset system comprised of an at least one swapping with reconfiguration station, a deployable asset operable to transport an at least one deployable cargo whereby the at least one deployable cargo is an energy storage device, a first location having a first docking port and a first energy storage capacity for the energy storage device, a second location having a second docking port and a second energy storage capacity for the energy storage device; whereby the at least one swapping with reconfiguration station is operable to vary the configuration of the deployable cargo from a first deployable cargo physical parameter set to a second deployable cargo physical parameter set; and whereby the first docking port is different than the second docking port.

19. The reconfigurable asset system comprised of claim 18 is further comprised of a dynamic routing system whereby the dynamic routing system chooses the at least one deployable cargo from the first location, chooses the second location, and chooses the at least one swapping with reconfiguration station in which the at least one deployable cargo is reconfigured from the first deployable cargo physical parameter set to the second deployable cargo physical parameter set; and whereby the second deployable cargo physical parameter set deviates from the first deployable cargo physical parameter set due to an at least one variation of time of day or seasonal between the first location and the second location.

20. The reconfigurable asset system comprised of claim 18 is further comprised of a dynamic routing system and a feedforward control system to establish a feedforward schedule database of the at least one deployable cargo from the first location to the swapping with reconfiguration station and then from the swapping with reconfiguration station to the second location as a function of any individual or combination of a prioritization response system, a feedback schedule database, an environmental system, or a dynamic pricing system.
